(19) United States
(12) Patent Application Publication
(10) Pub. No.: US 2006/0126455 A1
(43) Pub. Date: Jun. 15, 2006

(54) Tracking device

(75) Inventor: Toru Ikeda, Kawasaki (JP)

Correspondence Address: Patrick G. Burns;GREER, BURNS & CRAIN, LTD., Suite 2500, 300 South Wacker Dr., Chicago, IL, 60606, US

(73) Assignee: FUJITSU LIMITED

(21) Appl. No.: 11/344,680

(22) Filed: Jan. 31, 2006

Related U.S. Application Data
(63) Continuation of application No. PCT/JP03/11773, filed on Sep. 16, 2003.

(51) Int. Cl. G11B 7/00

(52) U.S. Cl. 369/44.28; 369/44.29; 369/44.25

(57) ABSTRACT

An MPU vibrates a track actuator with a predetermined amplitude while the focus servo loop is closed. The MPU calculates the number of tracks on a disk that the actuator crosses from a track error signal obtained by the vibration, and calculates the acceleration performance constant of the track actuator from the ratio between the calculated number of crossed tracks and a reference number of crossed tracks.

### CROSS-REFERENCE TO RELATED APPLICATION

This is a continuation of Application PCT/JP2003/011773, filed on Sep. 16, 2003, now pending, the contents of which are herein wholly incorporated by reference.

### BACKGROUND OF THE INVENTION

1. Field of the Invention

The present invention relates to a tracking device.

2. Description of the Prior Art

A conventional tracking device measures a track servo loop gain (an open loop gain) at a reference frequency, and corrects a track actuator acceleration performance constant such that a gain at the reference frequency becomes a reference value.

The conventional tracking device has, as hardware, at least a lens position signal indicating a relative positional deviation amount between a track actuator and a carriage.

The relative positional deviation amount between a track actuator and a carriage refers to a moving distance of the track actuator from a reference point on the carriage.

There is also a two-stage tracking control mechanism not having a lens position signal. However, the two-stage tracking control mechanism has a feedback loop for sequentially estimating the relative positional deviation between a track actuator and a carriage based on a track driving indication value to reduce the relative positional deviation to zero.

As a method of sequentially estimating the relative positional deviation between a track actuator and a carriage based on a track driving indication value, there is a method of filtering the track driving indication value through a transmission function model of the track actuator.

However, even the above method does not include a method of absorbing fluctuation in a displacement amount of the track driving indication value with respect to a DC component.

Also, in the above method, it is necessary to realize a high rank filter, which makes control complicated.

Note that, by measuring a track servo loop gain near a track servo band, driving sensitivity in the frequency band of the track servo band can be corrected to some extent. However, fluctuation of a primary resonance frequency of the track actuator causes to fluctuate driving sensitivity in a low-frequency band near a direct current.

Patent Document 1

JP 05-258330 A

Patent Document 2

JP 05-159318 A

Patent Document 3

JP 06-274913 A

Patent Document 4

JP 2000-67446 A

Patent Document 5

JP 11-161968 A

Patent Document 6

JP 11-45444 A

As error factors for determining a track servo loop gain, there are a track error signal sensitivity error and a track actuator acceleration performance error.

In the conventional technique, first, an amplitude of a track error signal is measured for the purpose of correcting the track error signal sensitivity error.

In the conventional technique, sensitivity correction gain means on an input side is adjusted such that the amplitude becomes a reference level.

In the conventional technique, a track servo loop gain is measured for the purpose of correcting the track actuator acceleration performance error to correct a track actuator acceleration performance constant such that a gain at a reference frequency becomes a reference value.

However, in a system for correcting an amplitude of a track error signal and correcting a track error signal sensitivity error, an error due to distortion or the like of the track error signal is included. As a result, an error is also given to the track actuator acceleration performance constant.

Therefore, conventionally, in order to perform more stable seek servo operation, it has been desired to reduce an error of track actuator acceleration performance and it has been desired to adopt a correction system for a track actuator acceleration performance constant that is not affected by sensitivity of a track error signal.

A conventional track actuator driving sensitivity measuring method will be explained with reference to FIGS. 29 and 30.

FIGS. 29 and 30 are flowcharts of the conventional track actuator driving sensitivity measuring method.

In FIG. 29, first, in S2901, the conventional track actuator driving sensitivity measuring method turns off a track servo and, in S2902, adjusts an input gain Gi to make sensitivity [m/V] of a tracking error signal TES constant and stores the input gain Gi in a memory.

The conventional track actuator driving sensitivity measuring method measures a signal amplitude V and, when a value of the signal amplitude V becomes constant, treats sensitivity of a tracking error signal as being normalize, and adjusts the input gain Gi to change the signal amplitude.

When the adjustment and storage of the input gain Gi for making sensitivity of the tracking error signal (TES) constant end in S2902, in S2903, the conventional track actuator driving sensitivity measuring method turns on the track servo and, in S2904, calculates an output gain Go for setting an open loop gain Gk at a crossover frequency ωo of a servo system to 1 and stores the output gain Go in the memory.

FIG. 30 is a flowchart describing details of output gain adjustment processing in S2904 in FIG. 29.

The output gain adjustment processing is executed using an adjustment function of a DSP of a tracking device.

First, in S3001, the conventional track actuator driving sensitivity measuring method turns off a servo switch to cut off a loop in an output position of a feedback operation unit.

Subsequently, in S3002, the conventional track actuator driving sensitivity measuring method turns on the servo switch and inputs a sine waveform of a crossover frequency fo in a gain operation unit as a disturbance from a disturbance generator.

The disturbance sine waveform is subjected to gain operation in the gain operation unit and, then, drives the track actuator.

A change in a position of a light beam due to driving of the track actuator is inputted to the gain operation unit as a tracking error signal detected by a TES detecting unit.

In the gain operation unit, the input gain Gi measured in the processing in S2902 in FIG. 29 is set.

Therefore, in the conventional track actuator driving sensitivity measuring method, a tracking error signal normalized to fixed sensitivity is obtained in the gain operation unit and outputted through arithmetic processing of a PID operation unit.

In this state, in S3003 in FIG. 3, the conventional track actuator driving sensitivity measuring method reads a disturbance input Vi to an open loop of a position servo system and an output Vo of the PID operation unit and calculates an open loop gain Gk as Gk=Vo/Vi.

Subsequently, in S3004, the conventional track actuator driving sensitivity measuring method checks whether the open loop gain Gk is 1.

If the open loop gain Gk is 1, the conventional track actuator driving sensitivity measuring method proceeds to S3008 and stores an adjusted value of the output gain Go at this point in the memory.

When the open loop gain Gk is not 1 in S3004, in S3005, the conventional track actuator driving sensitivity measuring method checks whether the open loop gain Gk is larger than 1.

If the open loop gain Gk is larger than 1, the conventional track actuator driving sensitivity measuring method proceeds to S3006, lowers the output gain Go by a predetermined value ΔG, and returns to S3002. In S3003, the conventional track actuator driving sensitivity measuring method calculates an open loop gain from a disturbance input and an FB output according to disturbance injection of a sine waveform and, in S3004, repeats the processing until the open loop gain Gk becomes 1.

If the open loop gain Gk is smaller than 1 in S3005, in S3007, a predetermined gain ΔG is added to the output gain Go and, in 3004, the processing is repeated from S3002 until the open loop gain Gk becomes 1.

An example of a factor causing fluctuation in track error signal sensitivity adjusting means in the conventional system will be explained with reference to FIG. 31.

FIG. 31 is a conceptual diagram showing an example of a factor causing fluctuation in the track error signal sensitivity adjusting means in the conventional system.

In the conventional technique, when a track error signal is distorted and a peak sensitivity of the track error signal is deteriorated because of an optical factor or the like, a track error signal amplitude is adjusted to be constant to cause an error in normalization of track error signal sensitivity.

In this case, in the conventional technique, since the track error signal sensitivity is adjusted, sensitivity in a track center part becomes excessively large.

There is an example of a case in which inclination near a 0 point does not change and a vertex is rounded.

In other words, when an amplitude is adjusted to be constant, sensitivity near the 0 point becomes excessively large.

In a state in which the track error signal sensitivity has an error, when a track servo loop gain is adjusted and a result of the adjustment is reflected as a track actuator acceleration performance constant, an error is given to the track actuator acceleration performance constant.

On the other hand, in a control system for detecting that a relative positional deviation amount between a track actuator and a carriage increases to a specified amount or more and driving the carriage, when a relative positional deviation amount between a track actuator and a carriage detected from a DC component of a track driving indication value has an error, a displacement amount for driving the carriage varies depending on an apparatus.

When the error is large, the carriage may not be positioned to a target track.

When the relative positional deviation amount becomes excessively large, deviation of an allowable track error center may occur, which may become a cause of deterioration in a recording/reproduction characteristic and a cause of deterioration in adjacent track data.

In a case where a change in a relative position between a track actuator and a carriage occurs at the time when the carriage is driven, it is necessary to reflect the change on a DC component of a track driving indication value and correct the DC component. However, an amount of the correction may be incorrect depending on an apparatus and act as a disturbance.

One of objects of the present invention is to provide a tracking device that calculates an acceleration performance constant of a track actuator without being affected by sensitivity of a track error signal.

One of objects of the present invention is to provide a tracking device that accurately calculates a driving sensitivity coefficient of a track driving indication value per a unit distance.

### SUMMERY OF THE INVENTION

A tracking device according to the present invention is characterized by including:

an oscillating unit oscillating a track actuator in a state in which a focus servo loop is closed;

a number-of-track-traverses calculating unit calculating a number of track traverses of the track actuator traversing tracks of an information recording medium from a track error signal obtained by the oscillation; and

an acceleration performance calculating unit calculating an acceleration performance constant of the track actuator from a value based on a ratio of the number of track traverses calculated and a reference number of track traverses.

The tracking device according to the present invention is characterized in that the value based on a ratio of the number of track traverses calculated and a reference number of track traverses is a ratio of a distance obtained by multiplying the calculated number of track traverses by a pitch of the tracks and a value corresponding to a distance obtained by multiplying the reference number of track traverses by the pitch of the tracks.

The tracking device according to the present invention is characterized in that the calculation of the number of track traverses by the number-of-track-traverses calculating unit is performed in a state in which rotation of the information recording medium is stopped.

The tracking device according to the present invention is characterized in that the oscillating unit sets an oscillation frequency of the track actuator to a frequency larger than a primary resonance frequency of the track actuator.

The tracking device according to the present invention is characterized in that

the oscillating unit sets, assuming that n is a natural number, an oscillation period of the track actuator to a period 1/n times as large as a rotation period of the information recording medium,

the number-of-track-traverses calculating unit calculates, assuming that k is ½ or a natural number, a first number of track traverses while the track actuator is oscillated by the oscillating unit and the information recording medium rotates k times, calculates a second number of track traverses due to eccentricity of the information recording medium while the information recording medium rotates k times in a state in which the track actuator is not oscillated by the oscillating unit, and calculates a third number of track traverses by subtracting the second number of track traverses from the first number of track traverses, and

the acceleration performance calculating unit calculates an acceleration performance constant of the track actuator from a ratio of the third number of track traverses and the reference number of track traverses.

A tracking device according to the present invention is characterized by including:

a track actuator supported by a carriage;

a first measuring unit measuring a first value of a track driving indication value at a specific rotation angle during rotation of an information recording medium in a state in which the track actuator is located in a first position on the carriage and a track servo loop is closed and measures a second value of the track driving indication value at a rotation angle identical with the specific rotation angle in a state in which the carriage is not driven, the track actuator is located in a second position on the carriage shifted by a predetermined number of tracks from the first position, and the track servo loop is closed; and

a control unit calculating a driving sensitivity coefficient of a track driving indication value by dividing a difference between the first value and the second value measured by a distance between the first position and the second position on the carriage obtained from the predetermined number of tracks.

The tracking device according to the present invention is characterized by further including moving unit that causes the track actuator to spirally follow tracks of the information recording medium and moves the track actuator by the predetermined number of tracks.

The tracking device according to the present invention is characterized by further including moving unit that causes the track actuator to perform track jump and moves the track actuator by the predetermined number of tracks.

The tracking device according to the present invention is characterized in that the specific rotation angle is an angle at predetermined timing synchronizing with a rotation signal of a spindle motor.

The tracking device according to the present invention is characterized by further including output unit that detects a relative positional deviation amount between the track actuator and the carriage by dividing a low-frequency component of the track driving indication value measured at predetermined timing by the driving sensitivity coefficient or detects a relative positional deviation amount between the track actuator and the carriage by dividing a low-frequency component of the track driving indication value by the driving sensitivity coefficient and, then, measuring the low-frequency component of the track driving indication value at predetermined timing and outputs, when the relative positional deviation amount between the track actuator and the carriage detected reaches a predetermined value, a signal for driving the carriage.

The tracking device according to the present invention further includes:

a second measuring unit measuring, when the carriage is driven, a low-frequency component of the track driving indication value at predetermined timing; and

a storing unit storing the track driving indication value measured by the second measuring unit, and is characterized in that

the control unit updates the low-frequency component of the track driving indication value stored in the storing unit with a value measured by the second measuring unit.

A tracking device according to the present invention is characterized by including:

a track actuator supported by a carriage;

a first measuring unit measuring a first value of a track driving indication value in a state in which rotation of an information recording medium is stopped, the track actuator is located in a first position on the carriage and a track servo loop is closed and measures a second value of the track driving indication value in a state in which rotation of an information recording medium is stopped, the carriage is not driven, the track actuator is located in a second position on the carriage shifted by a predetermined number of tracks from the first position, and the track servo loop is closed; and

a control unit calculating a driving sensitivity coefficient of a track driving indication value by dividing a difference between the first track driving indication value and the second track driving indication value by a distance between the first position and the second position on the carriage obtained from the predetermined number of tracks.

The tracking device according to the present invention is characterized by further including moving unit that causes the track actuator to perform track jump and moves the track actuator by the predetermined number of tracks.

The tracking device according to the present invention is characterized by further including output unit that detects a relative positional deviation amount between the track actuator and the carriage by dividing the track driving indication value measured by the driving sensitivity coefficient and outputs, when the relative positional deviation amount between the track actuator and the carriage detected reaches a predetermined value, a signal for driving the carriage.

The tracking device according to the present invention further includes:

a second measuring unit measuring, when the carriage is driven, the track driving indication value; and

a storing unit storing the track driving indication value measured by the second measuring unit, and is characterized in that

the control unit updates the track driving indication value stored in the storing unit with a value measured by the second measuring unit.

A tracking device according to the present invention is characterized by including:

a track actuator supported by a carriage;

a first measuring unit measuring a first value of a track driving indication value at a specific rotation angle during rotation of an information recording medium in a state in which the track actuator is located in a first position on the carriage and a track servo loop is closed and measures a second value of the track driving indication value at a rotation angle identical with the specific rotation angle in a state in which, while the track actuator continues to be located in a track identical with a track where the track actuator is located in the first position, the carriage is driven, the track actuator is located in a second position on the carriage shifted from the first position, and the track servo loop is closed; and

a control unit calculating a driving sensitivity coefficient of a track driving indication value by dividing a difference between the first value and the second value by a distance between the first position and the second position measured on the carriage obtained from a driving amount of the carriage.

The tracking device according to the present invention is characterized in that the specific rotation angle is an angle at timing synchronizing with a rotation signal of a spindle motor.

The tracking device according to the present invention further includes:

a second measuring unit measuring, when the carriage is driven, a low-frequency component of the track driving indication value at predetermined timing; and

a storing unit storing the track driving indication value measured by the second measuring unit, and is characterized in that

the control unit updates the low-frequency component of the track driving indication value stored in the storing unit with a value measured by the second measuring unit.

A tracking device according to the present invention is characterized by including:

a track actuator supported by a carriage;

a first measuring unit measuring a first track driving indication value in a state in which the track actuator is located in a first position on the carriage, rotation of an information recording unit is stopped, and a track servo loop is closed and measures a second track driving indication value in a state in which, while the track actuator continues to be located in a track identical with a track where the track actuator is located in the first position, the carriage is driven, the track actuator is located in a second position on the carriage shifted from the first position, rotation of the information recording medium is stopped, and the track servo loop is closed; and

a control unit calculating a driving sensitivity coefficient for a track driving indication value by dividing a difference between the first track driving indication value and the second track driving indication value by a distance between the first position and the second position obtained from a driving amount of the carriage.

The tracking device according to the present invention further includes:

a second measuring unit measuring, when the carriage is driven, the track driving indication value; and

a storing unit storing the track driving indication value measured by the second measuring unit, and is characterized in that

the control unit updates the track driving indication value stored in the storing unit with a value measured by the second measuring unit.

The track actuator displacement amount is in a proportional relation with the track actuator acceleration indication. Depending on an individual apparatus, the track actuator displacement amount changes with respect to the track actuator acceleration indication because of an influence of driving circuit/actuator characteristics.

In a state in which the focus servo loop is closed, when the track actuator is oscillated at a specified amplitude, a track traverse state of the information recording medium of the track actuator appears in a track error signal. As an example of the information recording medium, there is a disk-like medium.

For example, it is possible to recognize the number of track traverses by slicing the track error signal at a zero point to binarize the track error signal and counting the signal binarized.

The number of traverses in this case changes according to track actuator acceleration performance.

In the present invention, a ratio of the number of track traverses obtained to the number of traverses at the time when the track actuator is accelerated which serves as a reference, is calculated.

In the present invention, a result of the calculation is reflected on a gain for correcting the track actuator acceleration performance, that is, a track actuator acceleration performance constant, to normalize acceleration of the track actuator with respect to the track actuator acceleration indication.

In the present invention, a ratio of the number of track traverses counted for plural periods and integrated to the number of track traverses (for plural periods) serving as a reference is calculated.

Alternatively, in the present invention, an average for one period of the number of track traverses integrated is calculated and a ratio of the average to the number of track traverses (for one period) serving as a reference is calculated.

Accordingly, it is possible to reduce an error factor due to noise or the like at the time of measurement.

When the information recording medium is rotated, since the number of track traverses due to eccentricity of the information recording medium is also counted, an error occurs.

Therefore, in the present invention, rotation of the information recording medium is stopped to perform measurement, whereby the number of track traverses due to eccentricity is not counted.

When the track actuator is oscillated at a frequency lower than the primary resonance frequency, fluctuation in a spring appears as an error.

Thus, in the present invention, the track actuator is oscillated at a frequency larger than the primary resonance frequency.

In the present invention, it is possible to obtain the number of track traverses due to eccentricity by counting the number of track traverses for a half rotation or one rotation in advance in a state in which the focus servo loop is closed. Alternatively, the number of track traverses due to eccentricity may be measured for k rotations.

In the present invention, the track actuator is oscillated at a period 1/n times as large as a rotation period to count the number of track traverses for k rotations.

In the present invention, the number of track traverses due to eccentricity for k rotations is subtracted from the number of track traverses.

In the present invention, a ratio of a result of the subtraction to the reference number of track traverses for k rotations is calculated to reflect the ratio on a gain for correcting acceleration performance of the track actuator, that is, an acceleration performance constant of the track actuator and normalize acceleration of the track actuator with respect to the track actuator acceleration indication.

The reference number of track traverses refers to the number of track traverses at the time when an ideal track actuator is oscillated. When the track actuator is driven for one period, the reference number of track traverses for one period is set. When the track actuator is driven for plural periods, the reference number of track traverses for plural periods is set.

Note that values based on the ratio of the number of track traverses to the reference number of track traverses calculated include the calculated ratio of the number of track traverses to the reference number of track traverses itself.

Moreover, in the present invention, in a state in which the track servo is closed, a track driving indication value at a specific rotation angle during rotation of a medium such as a disk is measured as a first value. Then, while the carriage is fixed (in a state in which the carriage is not displaced), the track actuator alone is moved to traverse plural tracks to cause relative positional deviation between the track actuator and the carriage. In that state, a track driving indication value at the identical rotation angle is measured as a second value, and a difference between the first value and the second value of the track servo driving indication value is calculated. A displacement distance is derived from a relation between the number of tracks and a track pitch among tracks in the measurement, and the difference between the first value and the second value of the track servo driving indication value is divided by the displacement distance to obtain a driving sensitivity coefficient of a track driving indication value per a unit distance.

It is desirable to use a low-frequency component obtained by a track servo operation as the track driving indication value in order to remove noise.

The low-frequency component of the track driving indication value includes a direct current.

In the present invention, the moving means causes the track actuator to spirally follow a track for a specified number of tracks in order to move the track actuator alone to traverse the plural tracks.

In the present invention, the moving means performs track jump to displace the track actuator by the specified number of tracks in order to move the track actuator alone to traverse the plural tracks.

In the present invention, a specific rotation angle is obtained by timing in synchronization with a rotation signal of the spindle motor.

According to the present invention, in a state in which the track servo is closed, rotation of the medium such as a disk is stopped, and the track servo driving indication value is measured as a first value. Then, while the carriage is fixed (in a state in which the carriage is not displaced), the track actuator alone is moved to traverse plural tracks to cause relative positional deviation between the track actuator and the carriage. In that state, a track servo driving indication value set as a second value is used to perform measurement again, and a difference between the first value and the second value of the track servo driving indication value is calculated. A displacement distance of the track actuator is derived from a relation between the number of tracks and a track pitch among tracks in the measurement, and the difference between the first value and the second value of the track servo driving indication value is divided by the displacement distance to obtain a driving sensitivity coefficient of a track driving indication value per a unit distance.

In the present invention, the low-frequency component of the track driving indication value is divided by the driving sensitivity coefficient or the low-frequency component is detected after dividing the track driving indication value by the driving sensitivity coefficient and a resultant output of the low-frequency component is set as a relative positional deviation amount between the track actuator and the carriage. The relative positional deviation amount is used to judge whether it is necessary to drive a device for driving the carriage at the occurrence of a specified relative positional deviation amount between the track actuator and the carriage.

In the present invention, a normalized driving sensitivity coefficient is divided by the track driving indication value or the low-frequency component of the track driving indication value to detect an accurate relative displacement amount between the track actuator and the carriage. Accordingly, a displacement amount to be a trigger for driving the carriage is normalized.

Normalizing means correcting the same driving amount as a driving amount desired by the control unit to be outputted by the driving system.

In the present invention, when the carriage is moved by a specified amount, a relative positional relation between the track actuator and the carriage changes from that before moving the carriage. In order to quickly stabilize the track servo, the control means calculates a track driving indication value from an amount of displacement of the carriage and rewrites the track driving indication value stored in the storing means to change the track driving indication value to a state after operating the carriage.

In the present invention, the track actuator supported on the carriage is provided. In a state in which the track servo loop is closed, a first track driving indication value at a specific rotation angle during one rotation of the disk is measured and the carriage is driven while being positioned in the identical track. In a state in which a relative positions of the carriage to the track actuator is shifted, a second track driving indication value at the identical rotation angle is measured, and a difference between the first track driving indication value and the second track driving indication value is divided by a relative positional deviation amount obtained from the number of tracks to calculate a driving sensitivity coefficient of a track driving indication value.

In the present invention, the specific rotation angle is an angle determined by timing in synchronization with a rotation signal of the spindle motor.

In the present invention, the track actuator supported on the carriage is provided. In a state in which disk rotation is stopped and the track servo loop is closed, a first track driving indication value is measured. The carriage is driven while further being located in the identical track. In a state in which relative positions of the track actuator and the carriage are shifted, a second track driving indication value is measured. A difference between the first track driving indication value and the second track driving indication value is divided by a relative positional deviation amount obtained from the number of tracks to calculate a driving sensitivity coefficient of a track driving indication value.

### BRIEF DESCRIPTION OF THE DRAWINGS

FIG. 1 is an internal block diagram of an optical disk apparatus to which a first embodiment of a tracking device according to the present invention is applied;

FIG. 2 is a schematic diagram of an enclosure in the optical disk apparatus shown in FIG. 1;

FIG. 3 is a block diagram of a servo system for seek control and on-track control implemented by a DSP provided in a control board in FIG. 1;

FIG. 4 is a functional block diagram of driving sensitivity measurement processing provided in the optical disk apparatus shown in FIG. 1 that is performed with a position servo control system in FIG. 3 as an object;

FIG. 5 is a flowchart of operations in the first embodiment of the tracking device according to the present invention;

FIG. 6 is a flowchart of operations of the first embodiment of the tracking device according to the present invention;

FIGS. 7A and 7B is a graph of a transmission characteristic of a track actuator supported by a spring on a carriage in the first embodiment of the tracking device according to the present invention;

FIG. 8 is a conceptual diagram showing an operation at the time when the track actuator is sine-driven at a fixed frequency and a fixed driving current, in the first embodiment of the tracking device according to the present invention;

FIG. 9 is a graph showing a gain of the position servo control system provided in the DSP in FIG. 4;

FIG. 10 is a flowchart of operations in a second embodiment of the tracking device according to the present invention;

FIG. 11 is a flowchart of operations in the second embodiment of the tracking device according to the present invention;

FIG. 12 is a partial schematic diagram of a lens actuator mounted on a carriage used in a third embodiment of the tracking device according to the present invention;

FIGS. 13A and 13B is a schematic diagram showing a relative positional relation between the carriage and a track actuator during tracking in the third embodiment of the tracking device according to the present invention;

FIG. 14 is an internal diagram of the tracking device in the case in which a focus error signal (FES) is inputted in the third embodiment of the tracking device according to the present invention;

FIG. 15 is an internal diagram of the tracking device in the case in which a track error signal (TES) is inputted in the third embodiment of the tracking device according to the present invention;

FIG. 16 is an internal block of a track control unit shown in FIGS. 14 and 15;

FIG. 17 is a graph showing deviation from a track center at the time when relative displacement of the track actuator and the carriage occurs in the third embodiment to the tracking device according to the present invention;

FIG. 18 is a conceptual diagram showing behaviors of a low-frequency component of a track driving indication value at the time when jump of one track is performed for one rotation of a medium and, from an identical track keep state, track jump is stopped for a period corresponding to a specified number of tracks, only the track actuator is caused to spirally follow the track with the carriage fixed, and the tracking device is brought into the identical track keep state again;

FIG. 19 is a flowchart of operations in the third embodiment of the tracking device according to the present invention;

FIGS. 20A and 20B is a conceptual diagram showing a track error signal, a track driving indication value, and a driving state of the carriage in the case in which the track actuator is caused to spirally follow a track in the third embodiment of the tracking device according to the present invention;

FIG. 21 is a conceptual diagram showing behaviors of a low-frequency component of a track driving indication value at the time when, from an identical track keep state realized by performing jump of one track for one rotation of an information recording medium, the track keep state is released during a period corresponding to a specified number of tracks, only the track actuator is caused to perform track jump with a carriage fixed, and the tracking device is brought into the identical track keep state again, in a fourth embodiment of the tracking device according to the present invention;

FIG. 22 is a flowchart of operations in the fourth embodiment of the tracking device according to the present invention;

FIG. 23 is a conceptual diagram showing a change in track drive indication before and after track jump when rotation of a disk serving as an information recording medium is stopped and, from a state in which a track servo loop is closed, the track jump is performed, in a fifth embodiment of the tracking device according to the present invention;

FIG. 24 is a flowchart of operations in the fifth embodiment of the tracking device according to the present invention;

FIG. 25 is a conceptual diagram showing a change in a low-frequency component of a track driving indication value before and after driving when a step motor is driven to rotate one step during identical track keep and a carriage is driven (50 [μm]), in a sixth embodiment of the tracking device according to the present invention;

FIG. 26 is a flowchart of operations in the sixth embodiment of the tracking device according to the present invention;

FIG. 27 is a conceptual diagram showing a change in a track driving indication value before and after driving when disk rotation is stopped and, from a state in which a track servo loop is closed, the step motor is driven to rotate one step and the carriage is driven (50 [μm]);

FIG. 28 is a flowchart of operations in a seventh embodiment of the tracking device according to the present invention;

FIG. 29 is a flowchart of a conventional track actuator driving sensitivity measuring method;

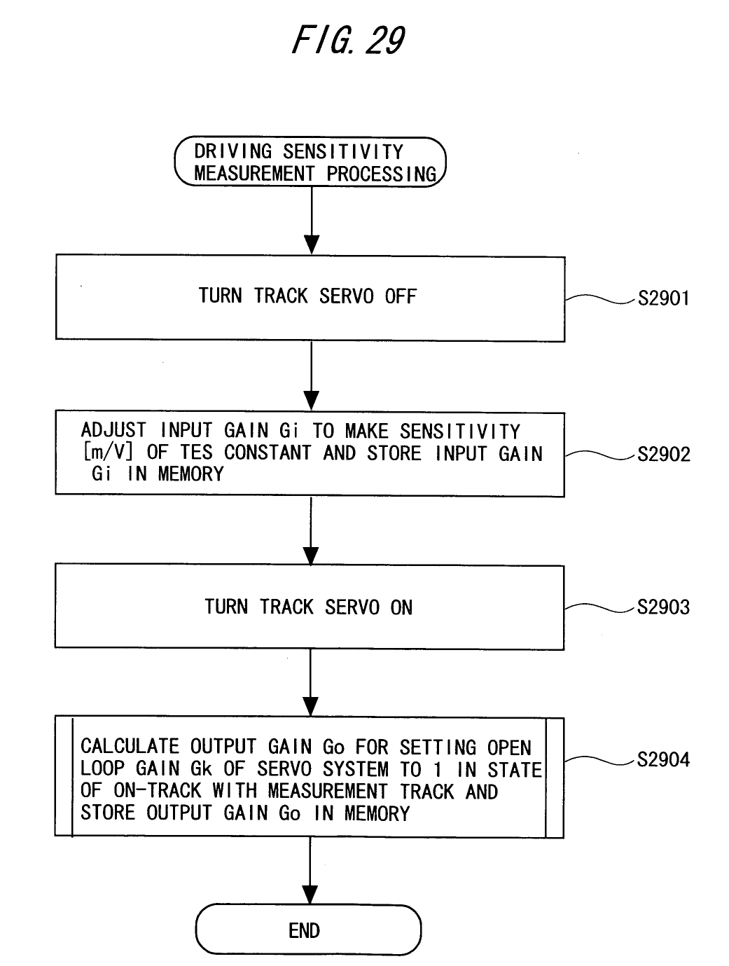

FIG. 30 is a flowchart of the conventional track actuator driving sensitivity measuring method; and

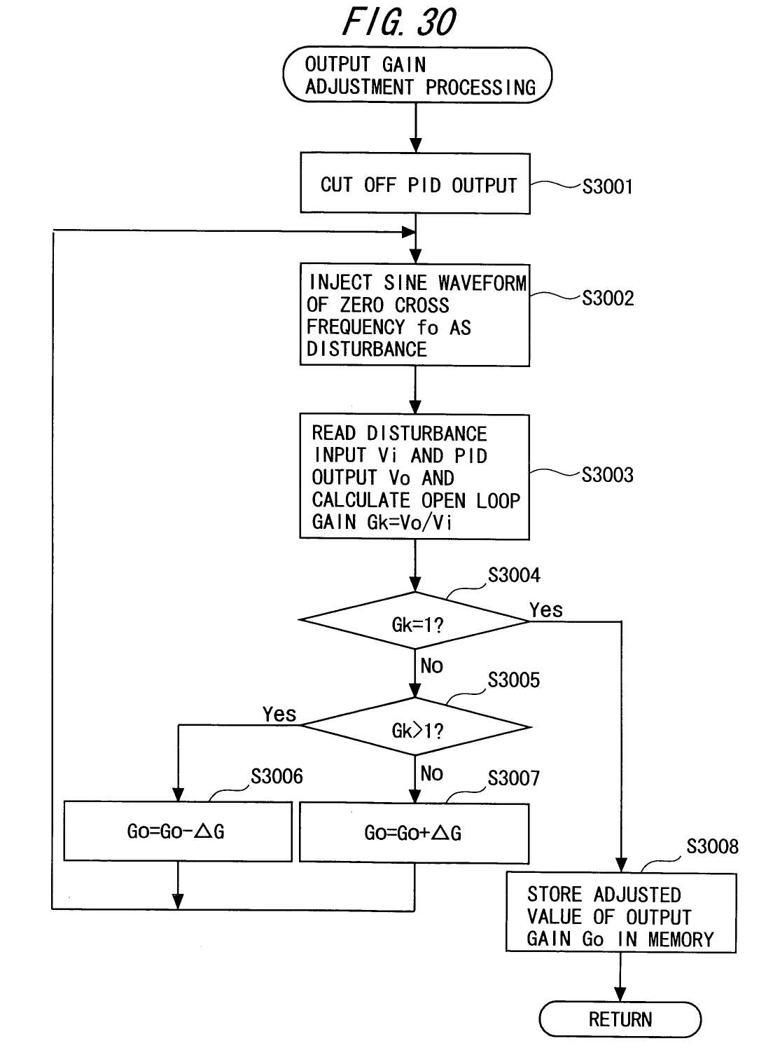

FIG. 31 is a conceptual diagram showing an example of a factor causing fluctuation in track error signal sensitivity adjusting means in a conventional system.

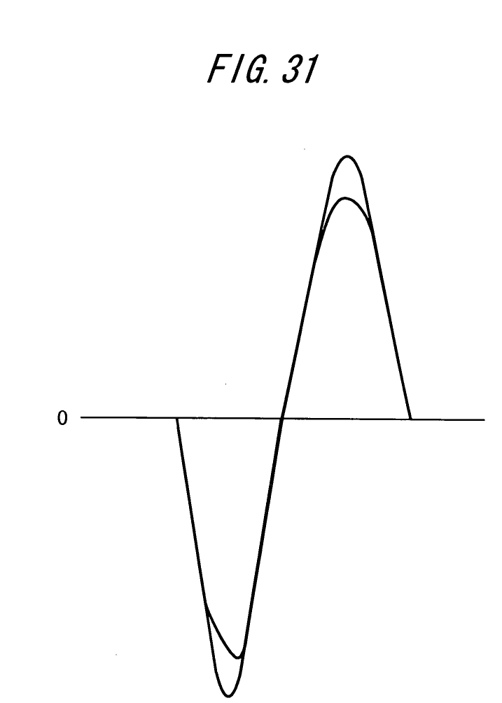

### DETAILED DESCRIPTION OF THE INVENTION

A best mode for carrying out the present invention will be hereinafter explained. Embodiments described below are examples. The present invention is not limited to constitutions of the embodiments.

(First Embodiment of a Tracking Device)

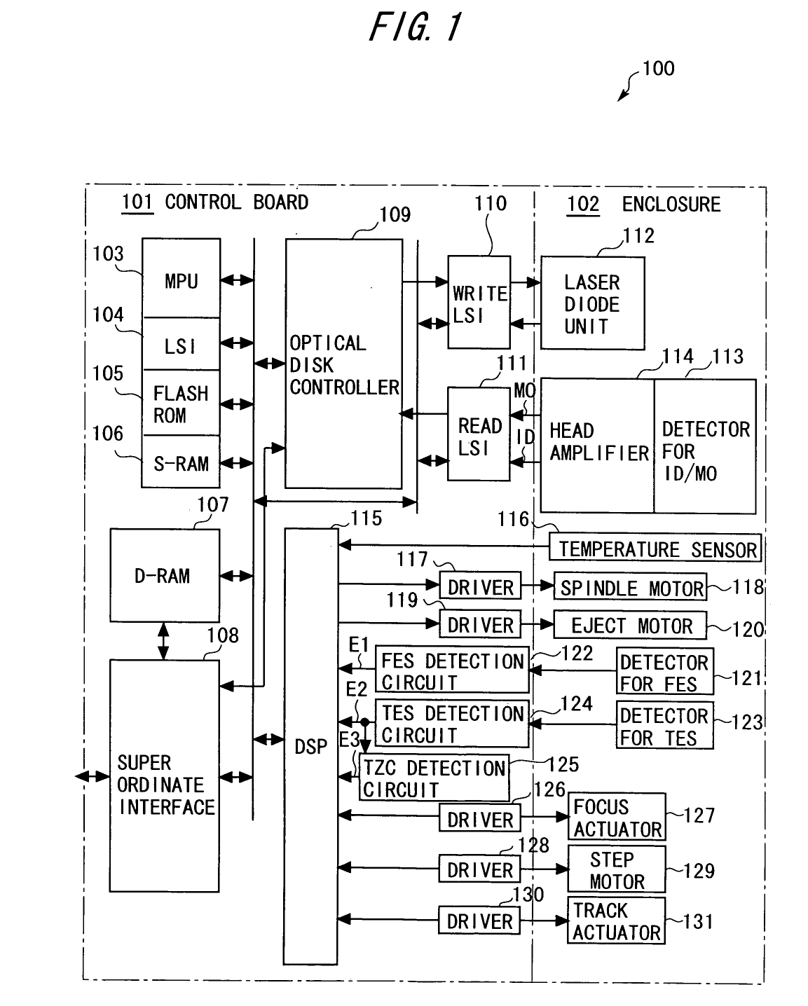

First, an internal structure of an optical disk apparatus to which a first embodiment of a tracking device according to the present invention is applied will be explained with reference to FIG. 1.

FIG. 1 is an internal block diagram of the optical disk apparatus to which the first embodiment of the tracking device according to the present invention is applied.

An optical disk apparatus 100 shown in FIG. 1 mainly includes a control board 101 and an enclosure 102.

In the control board 101, an MPU 103 that performs overall control for a DSP 115 and other units of the optical disk apparatus, a superordinate interface 108 that exchanges commands and data with a superordinate apparatus, an optical disk controller (ODC) 109 that performs processing necessary for reading data from and writing data in an optical disk medium, and the DSP 115 are provided.

The MPU 103 functions as oscillating means, number-of-track-traverses calculating means, and acceleration performance calculating means of the present invention.

An LSI 104 serving as a control logic, a flash ROM 105, an S-RAM 106, and a D-RAM 107 are provided for the MPU 103.

A coefficient L for correcting an acceleration performance constant of a track actuator obtained in this embodiment is stored in the flash ROM 105. The coefficient L will be described later.

The D-RAM 107 functions as a buffer memory and further secures a data buffer area that is used in cache control.

The optical disk controller 109 generates an ECC code by a unit of sector from NRZ write data and, then, converts the ECC code into, for example, a 1-7RLL code.

At the time of read access, the optical disk controller 109 subjects read data by a unit of sector to 1-7RLL inverse conversion and, then, performs error detection and correction with the ECC code, and transfers NRZ read data to the superordinate apparatus.

A write LSI 110 is provided for the optical disk controller 109.

A laser diode control output from the write LSI 110 is given to a laser diode unit 112 provided in an optical unit on the enclosure 102 side.

As a read system for the optical disk controller 109, a read LSI 111 is provided and a read demodulation circuit and a frequency synthesizer are built in the read LSI 111.

A reception signal of return light of a beam from a laser diode by a detector for ID/MO 113 provided in the enclosure 102 is inputted to the read LSI 111 via a head amplifier 114 as an ID signal and an MO signal.

Circuit functions such as an AGC circuit, a filter, and a sector mark detection circuit are provided in the read demodulation circuit of the read LSI 111. The read LSI 111 creates a read clock and read data from the ID signal and the MO signal inputted and demodulates PPM data or PWM data into the original NRZ data.

The read data demodulated by the read LSI 111 is given to the read system of the optical disk controller 109 and transferred to the superordinate apparatus as an NRZ data stream.

A detection signal of a temperature sensor 116 provided on the enclosure 102 side is given to the MPU 103 through the DSP 115.

The MPU 103 controls light emission powers of read, write, and erase of the laser diode to be optimum values on the basis of an environment temperature of units in the apparatus detected by the temperature sensor 116.

The MPU 103 controls a spindle motor 118 provided on the enclosure 102 side using a driver 117 through the DSP 115.

The MPU 103 controls a driver 119 through the DSP 115 at the time of ejection of an MO cartridge and drives an eject motor 120 to eject the MO cartridge.

The DSP 115 performs seek control and on-track control for seeking to be on-track a target track.

In the case of the seek control and the on-track control, the coefficient L for correcting an acceleration performance constant of the track actuator stored in the flash ROM 105 is read out and set in the servo system.

In order to realize a servo function of the DSP 115, a detector FES 121 that receives beam return light from a medium is provided in an optical unit on the enclosure 102 side.

An FES detection circuit (a focus error signal detection circuit) 122 creates a focus error signal E1 from a received light output of the detector for FES 121 and outputs the focus error signal E1 to the DSP 115.

A detector for TES 123 that receives beam return light from the medium is provided in the optical unit on the enclosure 102 side.

A TES detection circuit (a tracking error signal detection circuit) 124 creates a tracking error signal E2 from received light output of the detector for TES 123 and outputs the tracking error signal E2 to the DSP 115.

The tracking error signal E2 is inputted to a TZC detection circuit (a track zero cross detection circuit) 125. The TZC detection circuit 125 creates a track zero cross pulse E3 and inputs the track zero cross pulse E3 to the DSP 115.

The DSP 115 drives a focus actuator 127 via a driver 126 in order to control a position of a beam spot on the medium.

The DSP 115 drives a step motor 129 via a driver 128 in order to control a position of a beam spot on the medium.

The DSP 115 drives a track actuator 131 via a driver 130 in order to control a position of a beam spot on the medium.

In this way, a control block of the optical disk device may be identical with a dual axis track control mechanism. Carriage driving by the step motor 129 may be changed to carriage driving by a VCM or a DC motor.

Note that a result obtained by normalizing acceleration performance is used for driving sensitivity correcting means for a track loop, seek accelerating/decelerating means, and reaction correcting means at the time of carriage driving.

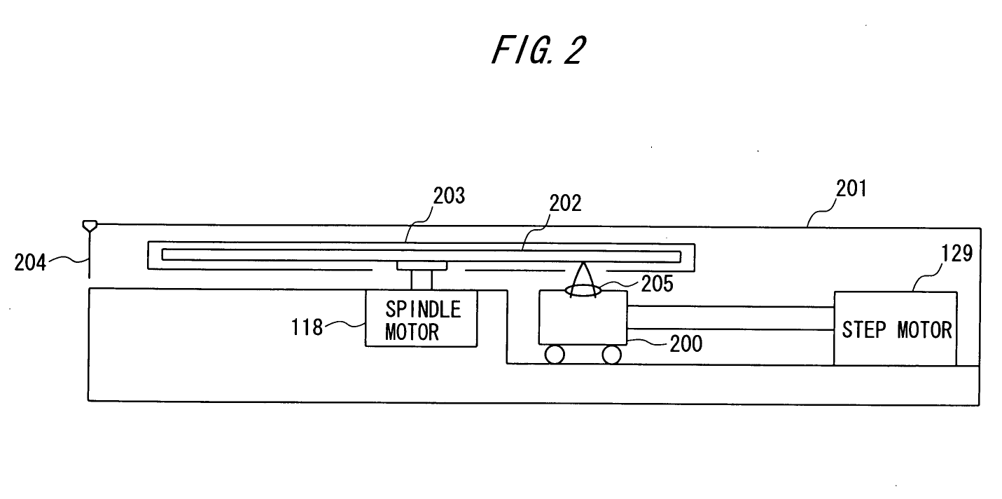

The enclosure 102 in the optical disk apparatus shown in FIG. 1 will be explained with reference to FIG. 2. FIG. 2 is a schematic diagram of an enclosure in the optical disk apparatus shown in FIG. 1.

The spindle motor 118 is provided in a housing 201. An MO cartridge 203 is inserted from an inlet door 204 side with respect to a hub of a rotation shaft of the spindle motor 118.

Consequently, an MO medium 202 in the MO cartridge 203 is mounted on the hub of the rotation shaft of the spindle motor 118 and loaded.

Below the MO medium 202 of the MO cartridge 203 loaded, the step motor 129 is provided and a carriage 200 mounted with an optical head is provided via a read screw.

The carriage 200 is arranged to be freely moved in a direction traversing tracks of the medium by the step motor 129.

An object lens 205 is mounted on the carriage 200. A beam is made incident on the object lens 205 from a laser diode provided in the optical head to focus a beam spot on a medium surface of the MO medium 202.

The object lens 205 is constituted to be moved in an optical axis direction by the focus actuator 127 shown in FIG. 1 and movable in the direction traversing the tracks by the track actuator 131.

It is possible to move the beam spot to a radial position of a target track by controlling the carriage 200 and the track actuator 131.

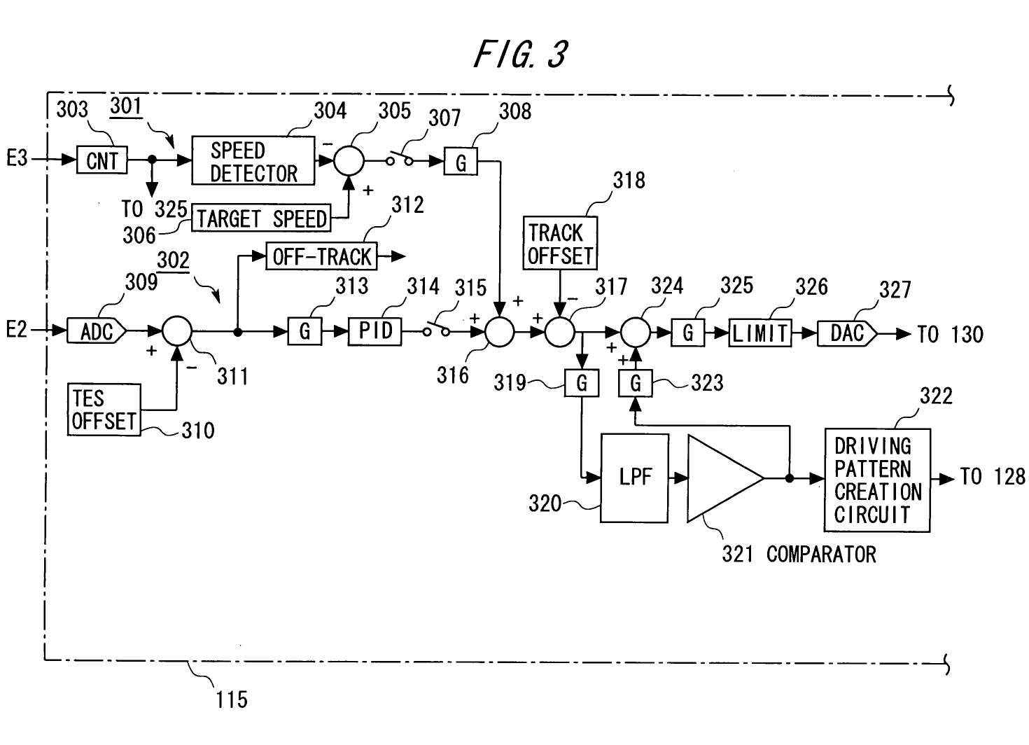

A function of the servo system for seek control and on-track control realized by the DSP 115 provided in the control board 101 shown in FIG. 1 will be explained with reference to FIG. 3. FIG. 3 is a functional block diagram of the servo system for seek control and on-track control realized by the DSP provided in the control board in FIG. 1.

The servo system includes a speed control system 301 for a track actuator and a position servo system (a first position servo system) 302 for a track actuator.

The servo system shown in FIG. 3 is a servo system that drives the track actuator 131 serving as a subject of low-speed seek control.

As described above, the servo system is divided into two systems, namely, the speed control system 301 and the position servo system 302.

The speed control system 301 inputs the track zero cross pulse E3 to the track counter 303, calculates time of a track zero cross interval according to a clock count, and calculates beam speed with a speed detector 304.

An error between an output of the speed detector 304 and target speed from a register 306 is calculated in an adder 305. The output is subjected to a speed error operation in a gain operation unit 308 via a servo switch 307 and, then, given to an adder 316.

The position servo system 302 for on-track control inputs the tracking error signal E2 from the TES detection circuit 124 in FIG. 1 to an AD converter 309.

The position servo system 302 for on-track control samples the tracking error signal E2 with a sample clock of a predetermined frequency and converts the tracking error signal E2 into digital data (hereinafter referred to as “TES data”) with the AD converter 309.

The TES data read in the AD converter 309 is subjected to an arithmetic operation to be added with an output from a TES offset 310 in an adder 311.

The TES data, which is read in the AD converter 309, outputted from the adder 311 is multiplied by a gain in the gain operation unit 313, subjected to proportional, integral, and differential operations in a PID operation unit (a PID filter) 314, and, then, inputted to the adder 316 via a servo switch 315.

The output of the adder 311 is also inputted to the off-track detector 312.

A speed error signal of the speed control system 301 and a tracking error signal of the position servo system 302 pass through the adder 316 and are subjected to track offset by a register 318 in an adder 317.

The tracking error signal is subjected to correction on the basis of an output from a comparator 321 in an adder 324.

The track error signal is subjected to sensitivity correction in a gain operation unit 325, then, passes through a limit 326, and is converted into an analog signal in a DA converter 327 and outputted to a driver 130 as a current indication value for a track actuator 131.

On the other hand, a signal after correction of the track offset is subjected to sensitivity correction in a gain operation unit 319 and inputted to a low-pass filter (LPF) 320.

Since a low-frequency component of a track driving indication value of a spring support type is proportional to a displacement amount of the track actuator, it is possible to use the low-frequency component as track direction position information of a lens.

A low-frequency component that is an output from the low-pass filter 320 is inputted to the comparator 321.

When detecting that the track actuator has reached a specified lens position, the comparator 321 outputs a result of the detection to a driving pattern creation circuit 322.

The driving pattern creation circuit 322 drives a step motor one step on the basis of the output from the comparator 321.

Moreover, at the time of step motor driving, reaction to the track actuator 131 following movement of the carriage 200 occurs.

Therefore, the output from the comparator 321 is subjected to sensitivity correction in the gain operation unit 323 and, then, reaction correction is applied to an output of the adder 317 via the adder 324. Consequently, reaction correction for the track actuator 131 is performed.

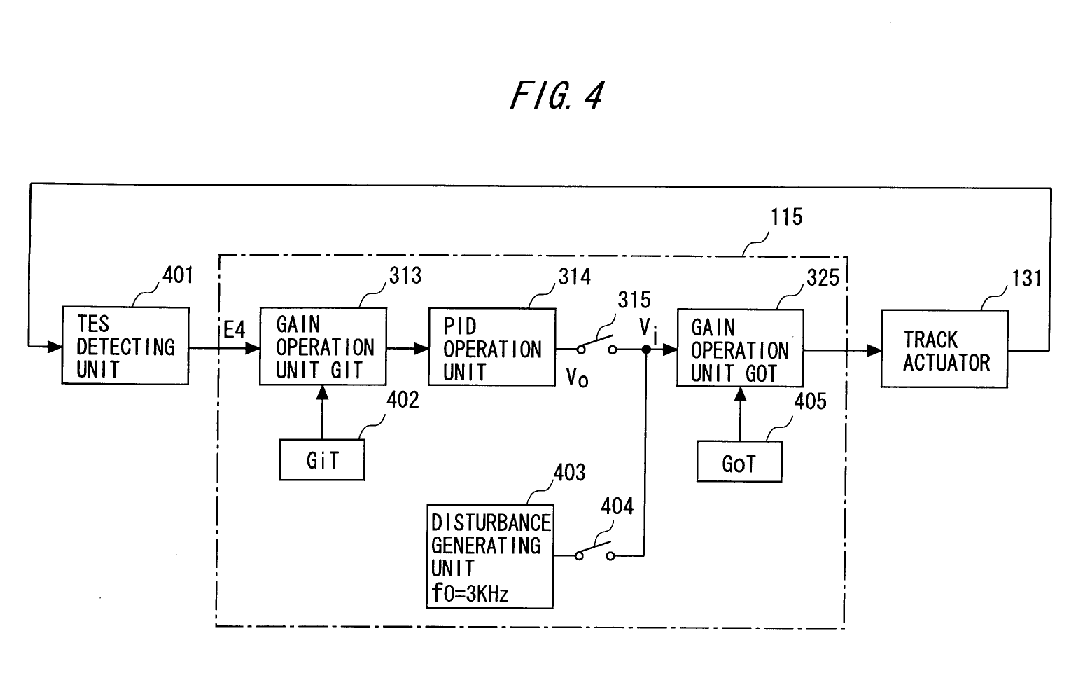

Function of driving sensitivity measurement processing provided in the optical disk apparatus 100 shown in FIG. 1, which is performed with the position servo control system 302 shown in FIG. 3 as an object, will be explained next with reference to FIG. 4. FIG. 4 is a functional block diagram of the driving sensitivity measurement processing provided in the optical disk apparatus shown in FIG. 1 that is performed with the position servo control system in FIG. 3 as an object.

In the driving sensitivity measuring processing, first, according to the function of the DSP 115, the gain operation unit 313 and the PID operation unit 314 of the position servo control system 302 and the gain operation unit 308 provided at an output stage on the speed control system 301 side in FIG. 3 are set as objects of measurement.

It goes without saying that, actually, the servo systems such as the AD converter 309, the servo switch 315, the adder 316, the adder 317, the adder 324, the gain operation unit 325, and the DA converter 327 are set as objects of the driving sensitivity measurement processing. However, in FIG. 4, a part of the servo systems are shown as functions of the DSP 115.

The position servo control system realized by the DSP 115 uses the track actuator 131 as a driving load. Position information according to driving of the track actuator 131 is fed back to the gain operation unit 313 of the DSP 115 as a tracking error signal E4 from a TES detection unit 401.

A disturbance generating unit 403, a servo switch 404, and a register 405 for the driving sensitivity measurement processing is provided for the position servo control system of the DSP 115.

A register 402 is used for setting change for the input gain Gi of the gain operation unit 313 provided at an input stage.

The register 405 is used for a setting change for the output gain Go of the gain operation unit 325 provided at an output stage.

The disturbance generating unit 403 generates a sine waveform of a crossover frequency fo of an open loop gain characteristic with respect to an angular frequency w of a loop driven by the track actuator 131 as a disturbance.

The generation frequency fo of the sine wave disturbance is in a range of, for example, fo=2 to 3 KHz.

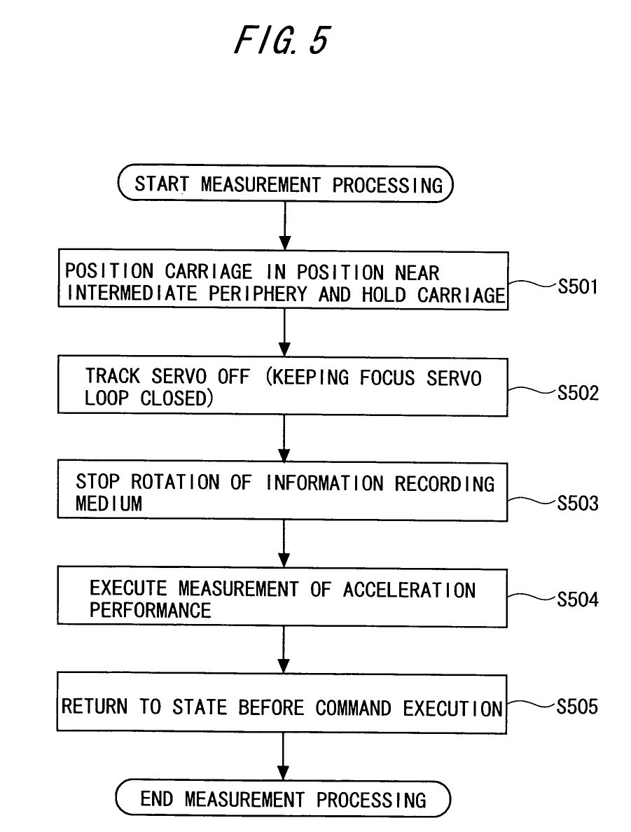

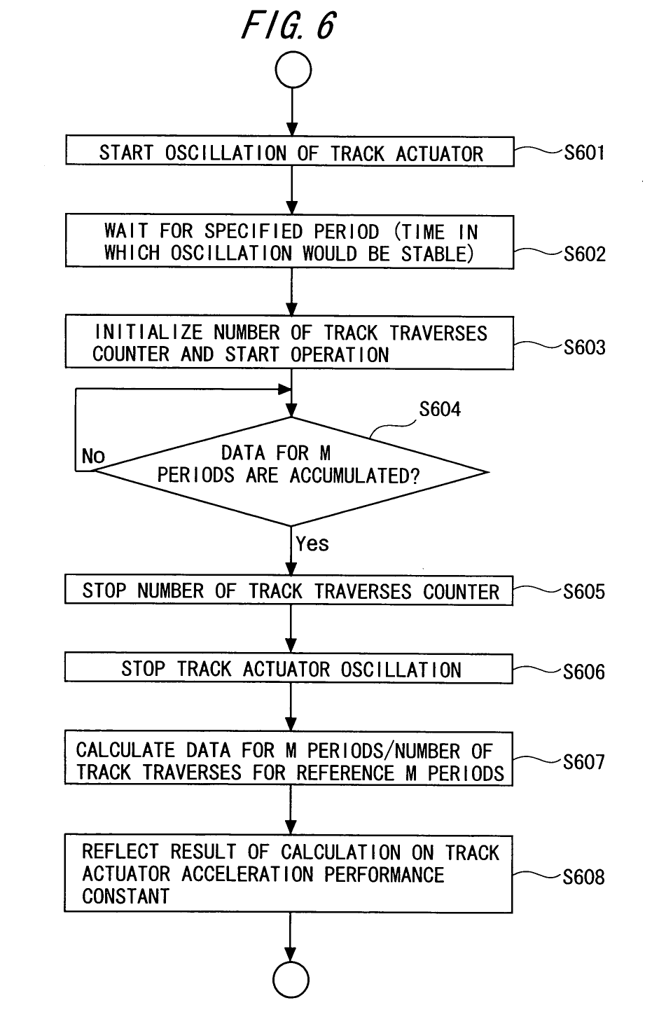

Operations of the first embodiment of the tracking device according to the present invention will be explained next with reference to the drawings. FIGS. 5 and 6 are flowcharts of operations of the first embodiment of the tracking device according to the present invention.

An operation in this embodiment is a method of measuring the number of track traverses without rotating a disk serving as an information recording medium.

A case in which the operation is performed according to a command from a superordinate apparatus is explained as an example. Processing in this embodiment may be incorporated in, for example, medium Load processing or servo error retry processing. However, for convenience of stopping rotation of the information recording medium, it is necessary to surely measure the number of track traverses outside a user data area.

In this embodiment, assuming that the operation is executed when an apparatus is started in a factory, a case in which the operation is executed in an intermediate peripheral part of the information recording medium is explained as an example.

In this embodiment, an MPU positions a carriage near an intermediate periphery from start of measurement. It is an object of this embodiment to position the carriage in a place where a groove is surely present on the information recording medium. The carriage does not always have to be positioned in the intermediate periphery.

The MPU holds the carriage in this state (position) to be in an immobile state (S501).

The MPU breaks a track servo loop to bring a focus servo loop into a closed state (S502).

The MPU stops rotation of the information recording medium while further keeping the state (S503).

After executing acceleration performance measurement processing (S504), the MPU returns to a state before execution of the processing (S505) and ends the operation.

An acceleration performance measurement execution step in S504 shown in FIG. 5 will be explained more in detail with reference to FIG. 6.

When the processing is started, the MPU starts the track actuator oscillating at a fixed frequency and a fixed amplitude (S601).

An oscillation frequency at this point is set to a value larger than a primary resonance frequency of the track actuator.

The MPU waits for time in which oscillation would be stably started (S602).

The MPU initializes a counter for the number of track traverses and starts a count operation (S603).

When data accumulation for m periods of oscillation ends, the MPU stops the counter for the number of track traverses and further stops the oscillation of the track actuator (S604, S605, and S606). It is assumed that m is a natural number. It is preferable that m be equal to or larger than 2.

The MPU calculates data for the m periods/the number of track traverses for reference m periods and reflects a result of the calculation on a track actuator acceleration performance constant (S607 and S608).

A ratio of the data for the m periods and the number of track traverses for the reference m periods is calculated. However, the MPU may calculate an average number of traverse tracks for one period and calculate a ratio of the average number of traverse tracks and a reference number of track traverses for one period.

In calculating the ratio, the number of traverse tracks actually measured and a period of the reference number of track traverses only has to be identical. Plural periods are set to reduce an influence due to noise or the like.

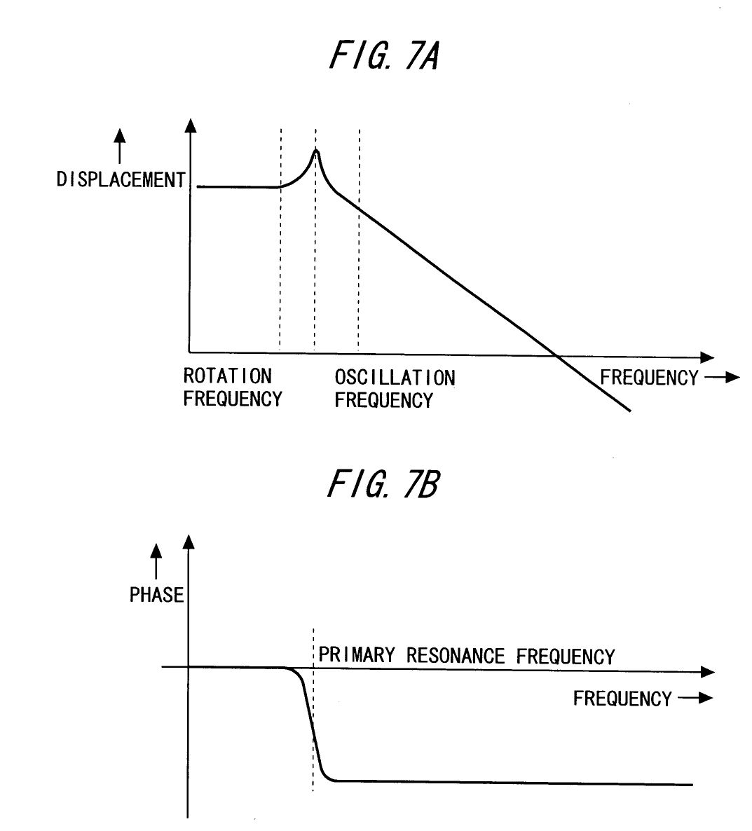

A transmission characteristic of a track actuator supported by a spring on a carriage in the first embodiment of the tracking device according to the present invention will be explained. FIGS. 7A and 7B is a graph of the transmission characteristic of the track actuator supported by the spring on the carriage in the first embodiment of the tracking device according to the present invention.

FIG. 7A is a graph at the time when the track actuator is driven with a driving current set constant and a displacement amount of the track actuator is indicated on an ordinate and a frequency of a track driving indication value is indicated on an abscissa. FIG. 7B is a graph at the time when a phase difference between a track driving indication value and track actuator displacement is indicated on an ordinate and a frequency of a track driving indication value is indicated on an abscissa.

Displacement is constant regardless of a frequency on a low-frequency side of a primary resonance frequency (a place where a peak is present in the figure).

On the other hand, on a high-frequency side, displacement has a characteristic that displacement attenuates at inclination of −40 dB/dec.

The characteristic is further explained. Displacement is plotted in a form translated vertically by changing a driving current at which the displacement becomes constant. Displacement is plotted in the same manner according to fluctuation in an actuator electromagnetic characteristic.

When there is fluctuation in a spring constant, the primary resonance frequency changes. When the spring is hardened, the primary resonance frequency shifts to the high-frequency side and a displacement amount decreases. When the spring is softened, the primary resonance frequency shifts to the low-frequency side and a displacement amount increases.

Therefore, it is an object of this embodiment to correct fluctuation in an actuator electromagnetic characteristic and fluctuation in a driving circuit.

An operation at the time when the track actuator is sin-driven at a fixed frequency and a fixed driving current in the first embodiment of the tracking device according to the present invention will be explained.

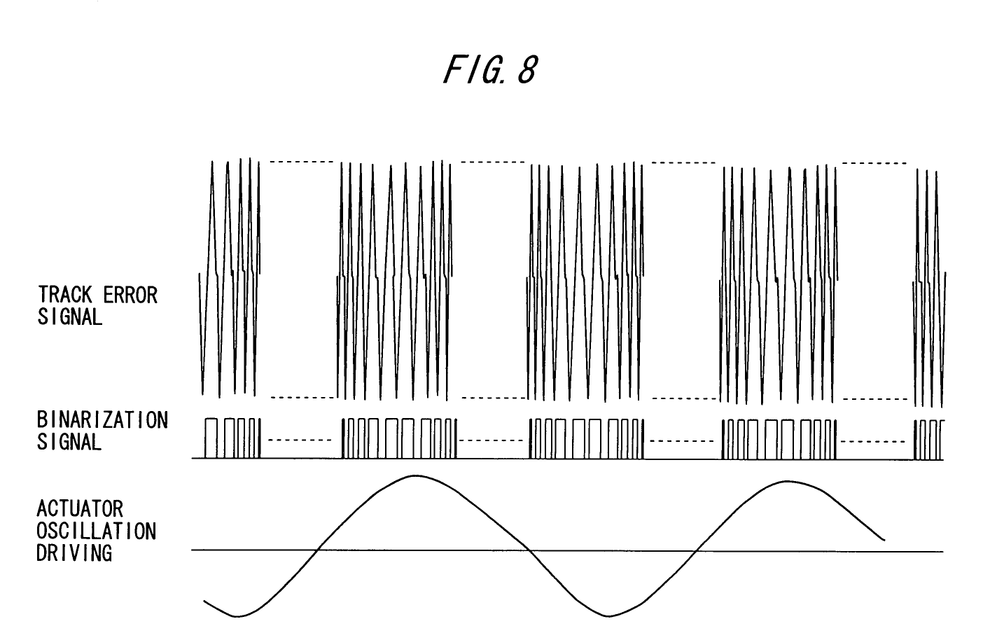

FIG. 8 is a conceptual diagram showing an operation at the time when the track actuator is sin-driven at a fixed frequency and a fixed driving current in the first embodiment of the tracking device according to the present invention.

In FIG. 8, a driving frequency of the track actuator is set to be higher than the primary resonance frequency.

Since the track actuator is sin-driven at a fixed frequency and a fixed driving current, the track actuator is accelerated and displaced relative to the carriage.

Since the track actuator is displaced, a track error signal is modulated.

The MPU binarizes the track error signal at a center voltage and counts the signal binarized. This makes it possible to represent a displacement amount of the track actuator.

It is possible to represent ideal acceleration at generated in the track actuator as αt=Ka×Kc×Ii×Sin ωt.

A constant Ka is an acceleration performance ratio (an electromagnetic characteristic constant) with respect to a driving current, Kc is an actual driving current ratio with respect to a driving current indication, and Ii is a driving current indication value.

A track actuator ideal displacement Xt is Xt=((Ka×Kc×Ii)/(ωˆ2))×Sin ωt. It is seen that αt and Xt are functions proportional to Ka×Kc.

The number of tracks in a sin one period is counted fourfold. It is possible to represent a maximum of track actuator displacement as Xtmax=(D×Tp)/4.

D is the number tracks counted in one period of sin driving and Tp is a pitch interval of tracks carved in an information recording medium.

An ideal condition is ((Ka×Kc×Ii)/(ωˆ2))=(D×Tp)/4. However, in a state in which there is fluctuation in an electromagnetic characteristic and a driving circuit characteristic, the condition is not satisfied.

Note that it is also possible to consider that ((Ka×Kc×Ii)/(ωˆ2)) is a distance obtained by multiplying the number of track traverses, which is a reference at the time when displacement is maximum, by a pitch of the tracks if ((Ka×Kc×Ii)/(ωˆ2)) is represented as ((Ka×Kc×Ii)/(ωˆ2)×Tp))×Tp.

Thus, generated acceleration is normalized as αtn with respect to the driving current indication value Ii by setting a coefficient L for correcting the fluctuation in an electromagnetic characteristic and a driving circuit characteristic as L=((Ka×Kc×Ii)/(ωˆ2))/((D×Tp)/4) and setting normalized αtn as αtn=L×(Ka×Kc)×Ii×Sin ωt. L×(Ka×Kc) is an acceleration performance constant of the track actuator of the present invention.

Note that, when L is represented as a ratio of the number of track traverses, L=((Ka×Kc×Ii)/((ωˆ2)×Tp))/(D/4).

In this way, it is possible to represent L as a ratio of displacement obtained by multiplying the number of track traverses D by the pitch of the tracks or as a ratio of the number of track traverses.

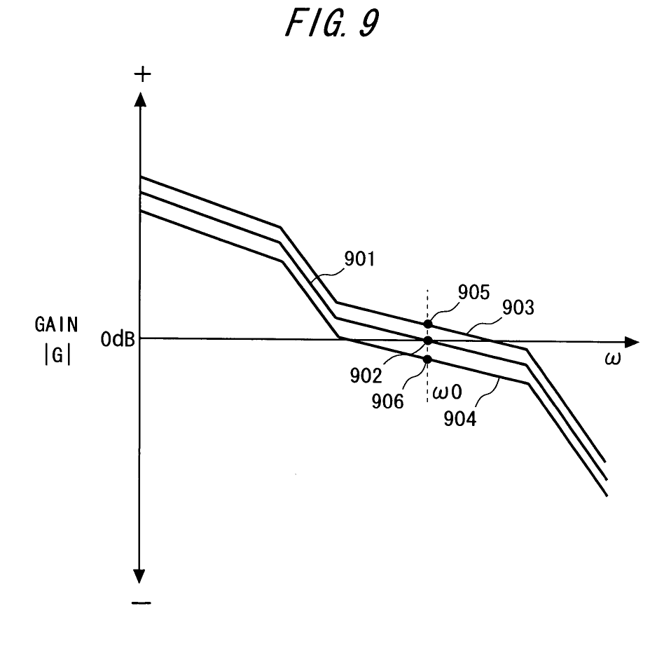

A gain of the position servo control system provided in the DSP 115 in FIG. 4 in the first embodiment of the tracking device according to the present invention will be explained. FIG. 9 is a graph showing a gain of the position servo control system provided in the DSP in FIG. 4.

In a graph in FIG. 9, a logarithmic amount 20 log10|G| of a gain G(jω) is indicated as a gain |G| [dB] on an ordinate with respect to an angular frequency ω [deg] on an abscissa. The graph shows an open loop gain characteristic curve 901 of the position servo control system shown in FIG. 4.

The open loop gain characteristic curve 901 passes a zero cross point 902 where a gain is 0 dB at an angular frequency ωo. The angular frequency ωo at the zero cross point 902 is a crossover frequency and, for example, ωo=2πfo. The angular frequency ωo takes a value in a range of fo=2 to 3 KHz.

If track error signal sensitivity and track actuator driving sensitivity take ideal values, the open loop gain characteristic curve 901 shown in FIG. 9 crosses zero at ωo.

When there is fluctuation in the track error signal sensitivity or the track actuator driving sensitivity, a zero cross frequency shifts as indicated by a curve 903 and a curve 904.

When it is assumed that the track error signal sensitivity becomes constant by specifically making an amplitude of a track error signal constant, the zero cross frequency shifts because of the fluctuation in the track actuator driving sensitivity.

However, when there is distortion in the track error signal, a relation of track sensitivity with respect to a track error signal amplitude is broken. As a result of performing the measurement, an error occurs in correction of track actuator driving sensitivity.

As explained above, according to the first embodiment of the tracking device according to the present invention, the track actuator is oscillated, a track actuator displacement amount is calculated from the number of track zero cross traverses, and an acceleration performance constant of the track actuator is calculated from a ratio of the track actuator displacement amount with respect to a specified displacement amount. Thus, it is possible to calculate an acceleration performance constant of the track actuator without being affected by sensitivity of the track error signal.

(Second Embodiment of the Tracking Device)

A second embodiment of the tracking device according to the present invention will be explained. This embodiment is different from the first embodiment of the tracking device in that measurement of the number of track zero cross traverses is performed in a state in which the information recording medium continues to be rotated. A constitution and the other operations of this embodiment are substantially the same as the constitution and the other operations of the first embodiment and the same explanation is applied. Thus, detailed explanations of the constitution and the other operations are omitted.

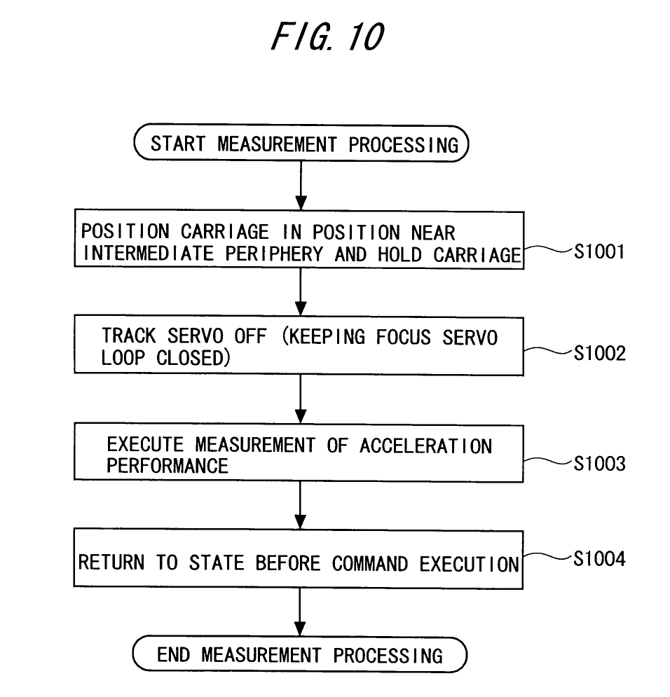

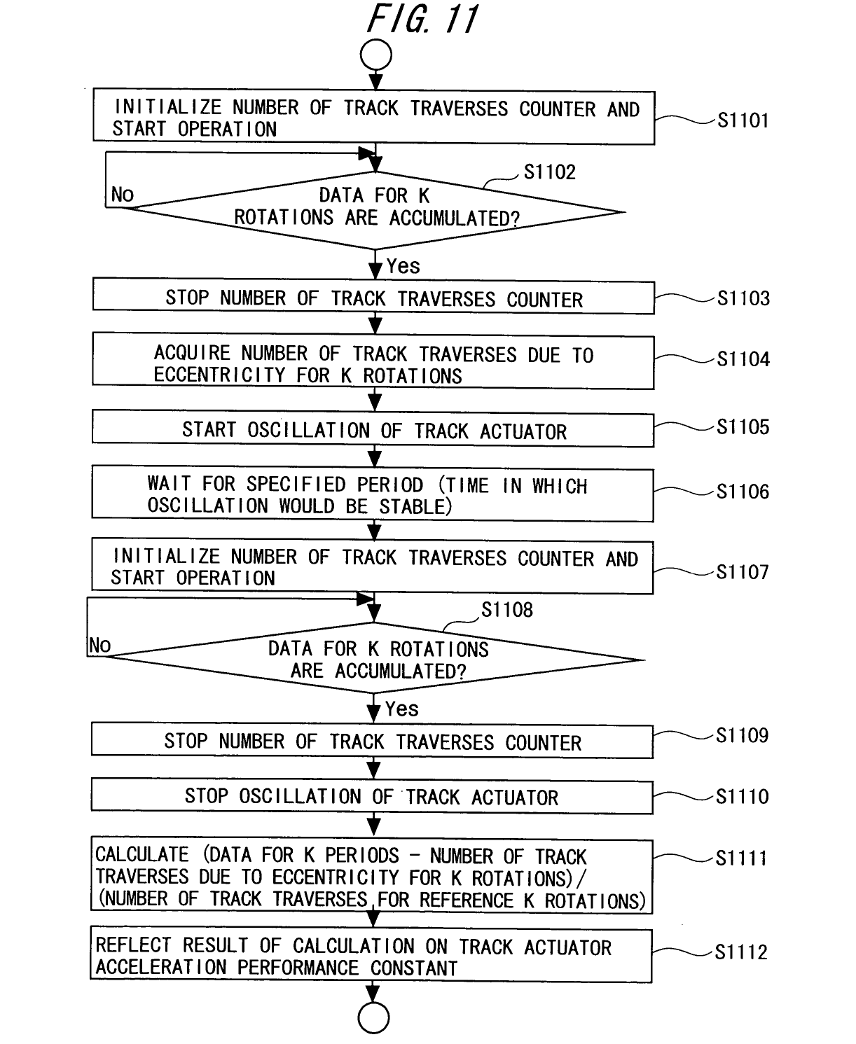

FIGS. 10 and 11 are flowcharts of operations of the second embodiment of the tracking device according to the present invention.

The processing may be executed when an apparatus is started in a factory or may be incorporated in Load processing or servo error retry processing executed in a user environment.

An MPU positions a carriage near an intermediate periphery from the start of measurement. It is an object of this embodiment to position the carriage in a place where a group is surely present on the medium. The carriage does not always have to be positioned in the intermediate periphery. The MPU holds the carriage in this state (position) to be in an immobile state (S1001).

The MPU breaks a track servo loop to bring a focus servo loop into a closed state (S1002).

After executing acceleration performance measurement processing, the MPU returns a state before execution of the processing and ends the operation (S1003, S1004).

An acceleration performance measurement execution step in S1003 shown in FIG. 10 will be explained more in detail with reference to FIG. 11.

When the processing is started, the MPU initializes a counter for the number of track traverses and starts a counter operation (S1101).

When data accumulation for k rotations ends, the MPU stops the counter for the number of track traverses and acquires the number of track traverses due to eccentricity for k rotations. Here, k is ½ or a natural number (S1102, 1103, and 1104).

The MPU starts oscillating the track actuator at a fixed frequency and amplitude (S1105).

An oscillation period at this point is 1/n of a medium rotation period and a frequency larger than a primary resonance frequency of the track actuator is set. Here, n is a natural number.

The MPU waits for time in which oscillation would be stably started, initializes the counter for the number of track traverses, and starts a counter operation (S1106 and S1107).

When data accumulation for k rotations ends, the MPU stops the counter for the number of track traverses and further stops the oscillation of the track actuator (S1108, S1109, and S1110).

The MPU calculates (data for k periods—the number of track traverses due to eccentricity for k rotations)/(the number of track traverses for reference k rotations) and reflects a result of the calculation on a track actuator acceleration performance constant (S1111 and S1112).

Note that, in this case, reflecting a result of the calculation on a track actuator acceleration performance constant means calculating a coefficient L and calculating normalized αtn according to the same calculation as the first embodiment of the tracking device according to the present invention.

Note that, although a ratio of data for k rotations and the number of track traverses for reference k rotations is calculated, it is also possible that an average number of traverse tracks for one rotation is calculated and a ratio of the average number of traverse tracks and the number of track traverses for reference one rotation is calculated.

In calculating the ratio, the number of traverse tracks actually measured and the number of times of rotation of the reference number of track traverses only has to be identical. Plural number of times of rotation are set to reduce an influence due to noise or the like.

The number of track traverses due to eccentricity is also described as being measured for k rotations. However, it is also possible that the number of track traverses is measured at least for ½ rotation and the number of track traverses due to eccentricity for k rotations is calculated.

In this way, in the second embodiment of the tracking device according to the present invention, as in the first embodiment of the tracking device according to the present invention, it is possible to calculate an acceleration performance constant of the track actuator without being affected by sensitivity of a track error signal.

(Third Embodiment of the Tracking Device)

A third embodiment of the tracking device according to the present invention will be explained with reference to the drawings.

First, an internal constitution of an optical disk apparatus to which the tracking device according to this embodiment is applied is substantially the same as that in FIG. 2 explained in the first embodiment. Therefore, substantially the same explanation as the optical disk apparatus explained with reference to FIG. 2 applies to the optical disk apparatus used in this embodiment, detailed explanations of the optical disk apparatus are omitted.

Note that it is an object of this embodiment to correct fluctuation in a spring constant including fluctuation in an actuator electromagnetic characteristic and fluctuation in a driving circuit characteristic.

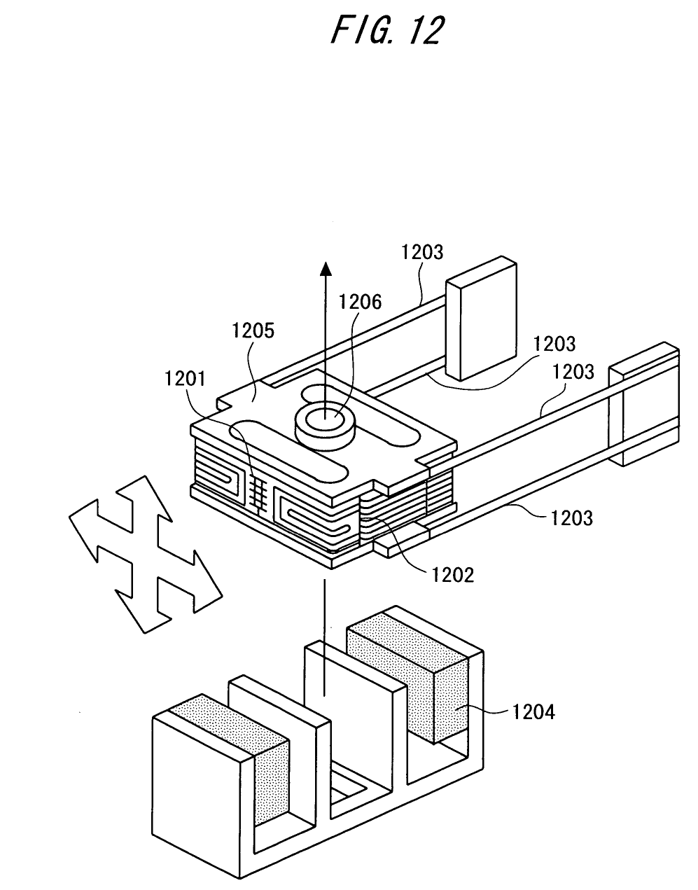

A lens actuator mounted on a carriage used in the third embodiment of the tracking device according to the present invention will be explained with reference to FIG. 12. FIG. 12 is a partial schematic diagram of the lens actuator mounted on the carriage used in the third embodiment of the tracking device according to the present invention.

A light beam emitted from a laser diode is narrowed down by an object lens 1206 mounted on a lens actuator 1205 through an optical element in an optical head and irradiated on an optical disk serving as an information recording medium.

The light beam irradiated on the optical disk is reflected on an optical disk reflection film and irradiated on a photodetector through the object lens 1206 and the optical element in the optical head.

In the photodetector, a light signal is converted into an electric current and a reproduction signal, a focus error signal, and a track error signal are generated from the electric current and connected to a controller board through an FPC cable.

A focus coil 1201 for focus direction driving and a tracking coil 1202 for track direction driving are mounted on the lens actuator 1205.

The lens actuator 1205 is driven by an electromagnetic force that is generated when electric currents fed to the coils act on a magnetic field of a magnet 1204.

The lens actuator 1205 is connected to the carriage by a wire 1203.

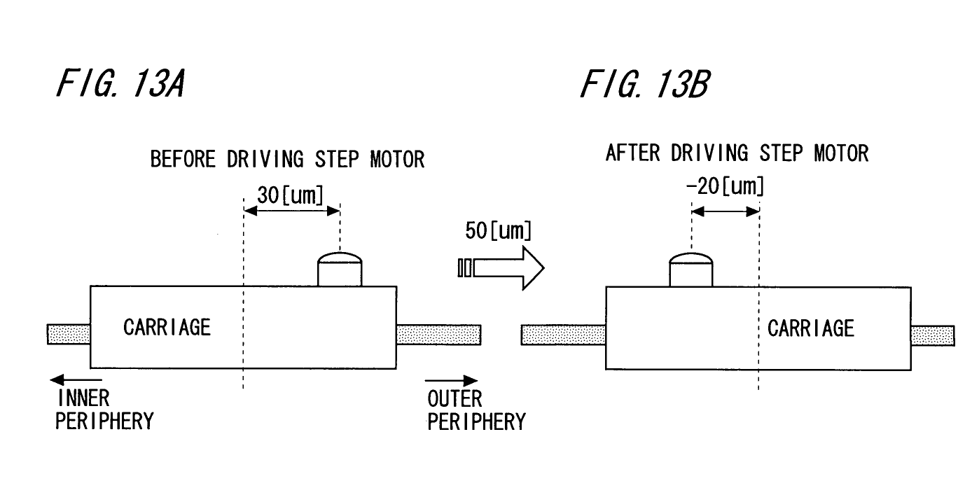

A relative positional relation between the carriage and the track actuator during tracking will be explained with reference to FIGS. 13A and 13B. FIGS. 13A and 13B is a schematic diagram showing a relative positional relation of the carriage and the track actuator during tracking in the third embodiment of the tracking device according to the present invention.

When deviation of center positions of the track actuator and the carriage exceeds, for example, 30 [μm] (FIG. 13A), a step motor is rotated for one pulse to move the carriage by 50 [μm] (FIG. 13B).

In this case, the track actuator after rotation is in a position −20 [μm] from the center position of the carriage.

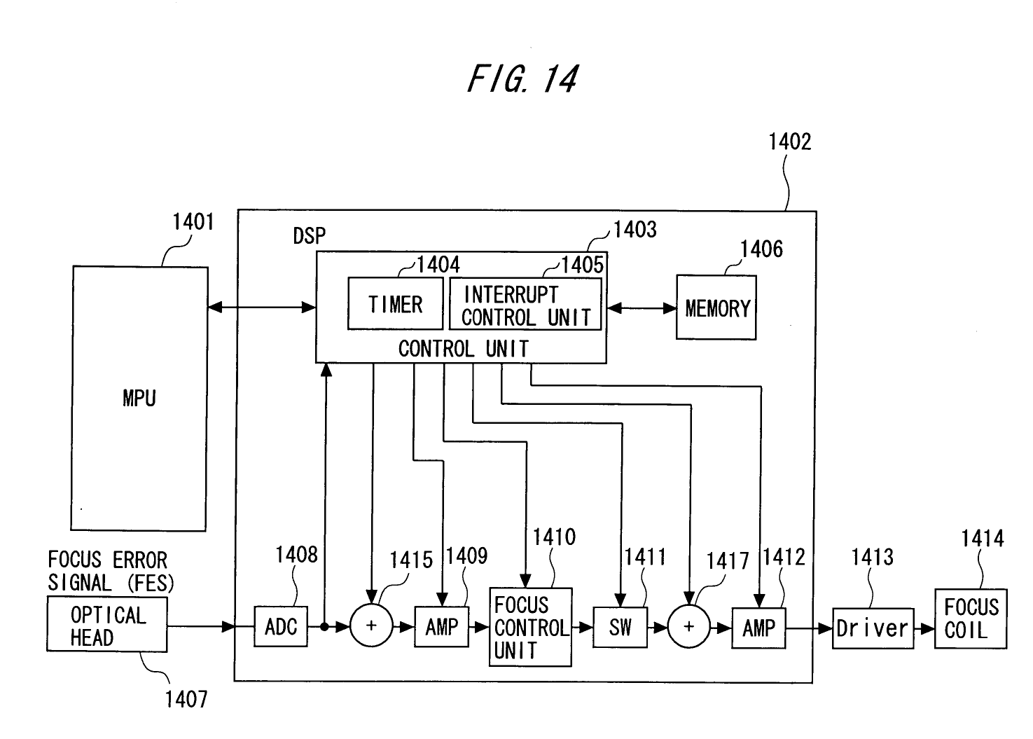

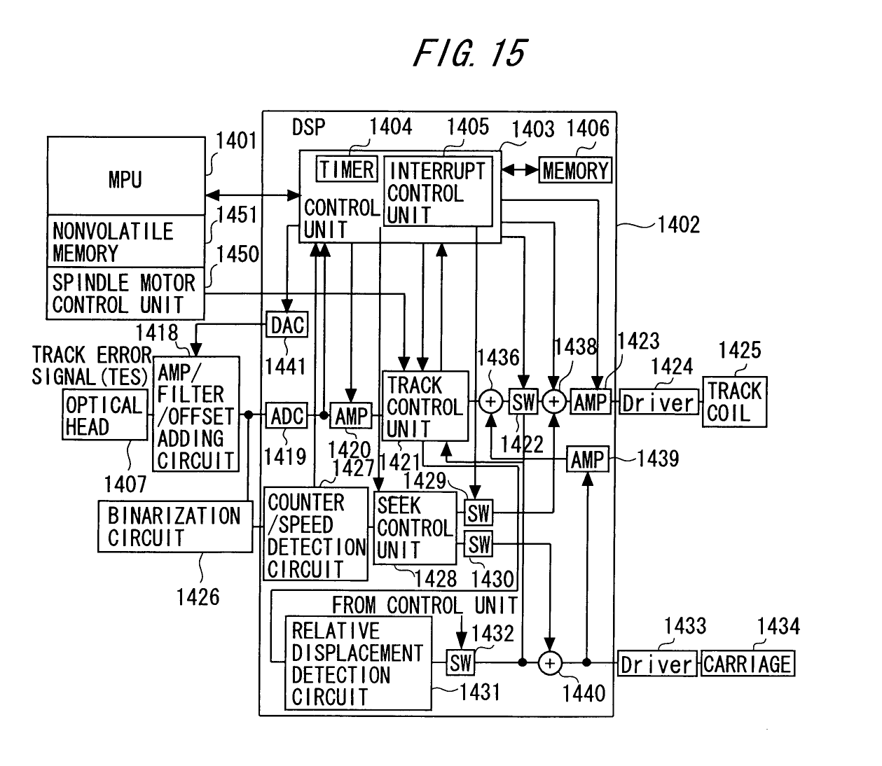

An internal structure in the third embodiment of the tracking device according to the present invention will be explained with reference to FIGS. 14 and 15. Note that, although MPUs and DSPs are shown in FIGS. 14 and 15, respectively, actually, the tracking device in this embodiment includes one MPU and one DSP.

FIG. 14 is an internal diagram of the tracking device in the case in which a focus error signal (FES) is inputted to the tracking device in the third embodiment of the tracking device according to the present invention. FIG. 15 is an internal diagram of the tracking device in the case in which a track error signal (TES) is inputted to the tracking device in the third embodiment of the tracking device according to the present invention.

In the tracking device in this embodiment, a case in which a step motor is used for carriage driving is explained as an example.

An MPU 1401 controls all units in the optical disk device such as a DSP 1402 and not shown lead LSI, write LSI, spindle control LSI, and superordinate interface LSI.

A light beam emitted from an optical head 1407 is reflected on a reflection film of an information recording medium and returns to the optical head 1407.

In the optical head 1407, a focus error signal representing a focus state of a light beam on a medium surface and a track error signal are created.

The focus error signal is inputted to an ADC 1408 in the DSP 1402 and an analog voltage signal is converted into a digital signal.

An output of the ADC 1408 is inputted to an adder 1415. The adder 1415 adds offset signals given by the MPU 1401 and a control unit 1403 of the DSP 1402 in various applications to the output. The output is inputted to an AMP 1409.

The control unit 1403 reads out a sensitivity correction gain stored in a memory 1406 and sets the sensitivity correction gain in the AMP 1409. The control unit 1403 functions as first measuring means, second measuring means, control means, and moving means of the present invention. The memory 1406 functions as storing means of the present invention.

The AMP 1409 multiplies an output of the adder 1415 by a sensitivity correction gain of the focus error signal.

A sensitivity correction gain value of the focus error signal is inputted to a focus control unit 1410.

In the focus control unit 1410, a digital filter operation is performed (PID, etc.) and a control signal for driving a focus coil is outputted.

An interrupt control unit 1405 is started at timing set in a timer 1404 and arithmetic processing is performed in the focus control unit 1410 at every fixed time according to timing given by the interrupt control unit 1405.

An output of the focus control unit 1410 is inputted to a switch circuit 1411.

The switch circuit 1411 is operated by the control unit 1403 to be turned on when a focus servo loop is closed and turned off when the focus servo loop is opened.

In an adder 1417, in a state in which the focus servo loop is opened, a focus driving signal is given from the control unit 1403 at the time of a focus search operation.

The control unit 1403 reads out a focus driving sensitivity correction gain value stored in the memory 1406 and sets the focus driving sensitivity correction gain value in an AMP 1412.

The AMP 1412 multiplies an output from the adder 1417 by the focus driving sensitivity correction gain.

In a driver 1413, an output voltage of the AMP 1412 is converted into a driving current signal of a focus coil 1414 to drive the focus coil 1414.

As shown in FIG. 15, a track error signal (TES) is inputted to an ADC 1419 in the DSP 1402 through an AMP/FILTER/offset adding circuit 1418 and an analog voltage signal is converted into a digital signal.

In the AMP/FILTER/offset adding circuit 1418, offset correction for the track error signal is performed.

The offset correction is performed when the control unit 1403 inputs an offset correction signal to the AMP/FILTER/offset adding circuit 1418 through a DAC 1441 such that a center of the track error signal converted into the digital signal in the ADC 1419 coincides with a reference signal.

An LPF that amplifies the track error signal and cuts off a high frequency is also included in the AMP/FILTER/offset adding circuit 1418.

The AMP/FILTER/offset adding circuit 1418 is inputted to the ADC 1419 of the DSP 1402 and a binarization circuit 1426.

As described above, the ADC 1419 converts an analog track error signal into a digital signal and outputs the digital signal.

The control unit 1403 reads out a track error signal sensitivity correction gain value stored in the memory 1406 and sets the track error signal sensitivity correction gain value in an AMP 1420.

The AMP 1420 performs track error signal sensitivity correction different for each type of a medium capacity.

An output from the AMP 1420 is inputted to a track control unit 1421.

In the track control unit 1421, a digital filter operation is performed (PID, etc.) and a control signal for driving a track coil 1425 is outputted.

The interrupt control unit 1405 is started at timing set in the timer 1404 and arithmetic processing is performed in the track control unit 1421 at every fixed time according to timing given by the interrupt control unit 1405.

An output from the track control unit 1421 drives the track coil 1425 through an adder 1436, a switch circuit 1422, an adder 1438, an AMP 1423, and a driver 1424.

In the adder 1436, a signal for correcting reaction generated at the time of carriage driving is added to the output.

This is because, in a two-stage tracking system by the track actuator supported by the spring on the carriage, it is necessary to correct reaction generated at the time of carriage driving.

The switch circuit 1422 is operated by the control unit 1403 to be turned on when a track servo loop is closed and turned off when the track servo loop is opened.

In the adder 1438, a track driving signal is given from the control unit 1403 in a state in which the track servo loop is opened.

The control unit 1403 reads out a track driving sensitivity correction gain value stored in the memory 1406 and sets the track driving sensitivity correction gain value in the AMP 1423.

The AMP 1423 multiplies an output from the adder 1438 by the track driving sensitivity correction gain.

In the driver 1424, an output voltage of the AMP 1423 is converted into a driving current signal for the track coil 1425 to drive the track coil 1425.

An output of the track control unit 1421 is inputted to a relative displacement detection circuit 1431.

In the two-stage tracking system by the track actuator supported by the spring on the carriage, it is necessary to detect a relative positional relation between the track actuator and the carriage, perform carriage driving when a specified displacement amount is generated, and keep a relative displacement amount in a specified range.

In a switch circuit 1432, it is possible to control ON and OFF of driving with the control unit 1403.

By performing carriage driving, relative displacement of the track actuator and the carriage is switched according to moving speed of the carriage. Therefore, the switch circuit 1432 outputs a change in a displacement amount corresponding to movement of the carriage to the track control unit 1421.

A carriage 1434 is driven on the basis of a signal sent through an adder 1440 and a driver 1433.

A path of the binarization circuit 1426 is used for seek control. During the seek control, the switch circuit 1422 and the switch circuit 1432 are turned off, a switch circuit 1429 and a switch circuit 1430 are turned on, and a control block is switched to the above explanation selectively.

In the binarization circuit 1426, a track error signal is compared at a reference voltage to be converted into a digital track cross signal.

A binarization signal from the binarization circuit 1426 is inputted to a counter/speed detection circuit 1427. A light beam moving distance and moving speed are detected according to a coefficient of the binarization signal.

In a seek control unit 1428, a control signal for driving the carriage or the track actuator is calculated according to the light beam moving distance and speed.

An output from the seek control unit 1428 is added to respective driving systems through the switch circuit 1429 and the switch circuit 1430.

A spindle motor control unit 1450 controlled by the MPU 1401 outputs a rotation synchronizing signal to the track control unit 1421.

The track control unit 1421 outputs a low-frequency component of a track driving indication value on the basis of the rotation synchronizing signal from the spindle motor 1450.

The low-frequency component of the track driving indication value outputted by the track control unit 1421 is outputted to the control unit 1403.

The control unit 1403 samples a track driving indication value that should be stored from the low-frequency component of the track driving indication value inputted and stores the track driving indication value in the memory 1406. The MPU 1401 is capable of referring to the track driving indication value stored in the memory 1406 at arbitrary timing through the control unit 1403.

When a step motor is used for carriage driving, in a track servo control unit, the low-frequency component of the track driving indication value outputted from the track control unit 1421 is outputted to the relative displacement detection circuit 1431.

An output of the relative displacement detection circuit 1431 is connected to a motor driver circuit 1433 through the switch circuit 1432 and the adder 1440.

The relative displacement detection circuit 1431 compares displacement of the track actuator and the carriage detected with a reference level. When displacement equal to or larger than a specified value on a positive side or a negative side (an outer side or an inner side) is detected, the relative displacement detection circuit 1431 outputs a pulse for driving the carriage 1434.

The relative displacement detection circuit 1431 detects displacement of the track actuator and the carriage from a low-frequency component of a track driving indication value. The relative displacement detection circuit 1431 functions as output means of the present invention.

The relative displacement detection circuit 1431 divides a low-frequency component of a track driving indication value measured at predetermined timing by a driving sensitivity coefficient to detect a relative positional deviation amount between the track actuator and the carriage or, after dividing the low-frequency component of the track driving indication value by the driving sensitivity coefficient, measures the low-frequency component of the track driving indication value at predetermined timing to detect a relative positional deviation amount between the track actuator and the carriage.

When the relative positional deviation amount between the track actuator and the carriage detected reaches a predetermined value, the relative displacement detection circuit 1431 outputs a signal for driving the carriage.

As the displacement equal to or larger than the specified value, for example, when a feed pitch by the step motor of the carriage is 50 μm, (50 μm/2)+α is set as 30 μm.

Explaining a case in which the track actuator and the carriage are displaced to the outer side as an example, when displacement between the track actuator and the carriage exceeding +30 μm is detected, the relative displacement detection circuit 1431 drives a step motor of the carriage 1434 to drive the carriage to the outer side.

Then, since one pitch is 50 μm, displacement between the track actuator and the carriage is 30−50=−20 μm.

An output of the seek control unit 1428 is connected to the adder 1440 through the switch circuit 1430. This makes it possible for the carriage alone to perform a moving operation.

Note that an output of the seek control unit 1428 and an output of the relative position detection circuit 1431 are exclusively controlled by the switch circuit 1430 and the switch circuit 1432.

The output of the relative position detection circuit 1431 is outputted to the track control unit 1421 through the AMP 1432.

The track control unit 1421 recognizes that the step motor is driven and recognizes a polarity of the step motor driving and instructs the control unit 1403 to rewrite a track driving indication value.

When the carriage is driven, the control unit 1403 rewrites a track driving indication value stored in the memory 1406 on the basis of the instruction from the track control unit 1421. In other words, the control means 1403 functions as second measuring means of the present invention and the memory 1406 functions as storing means of the present invention.

For example, in the example of step motor driving, the control unit 1403 sets a value equivalent to −20 μm in the memory 1406.

Since reaction is generated in the track actuator via the spring when the step motor is driven, a control amount equivalent to the reaction is given to the track coil 1425 through the AMP 1439.

Step motor driving at seek time is not specifically explained.

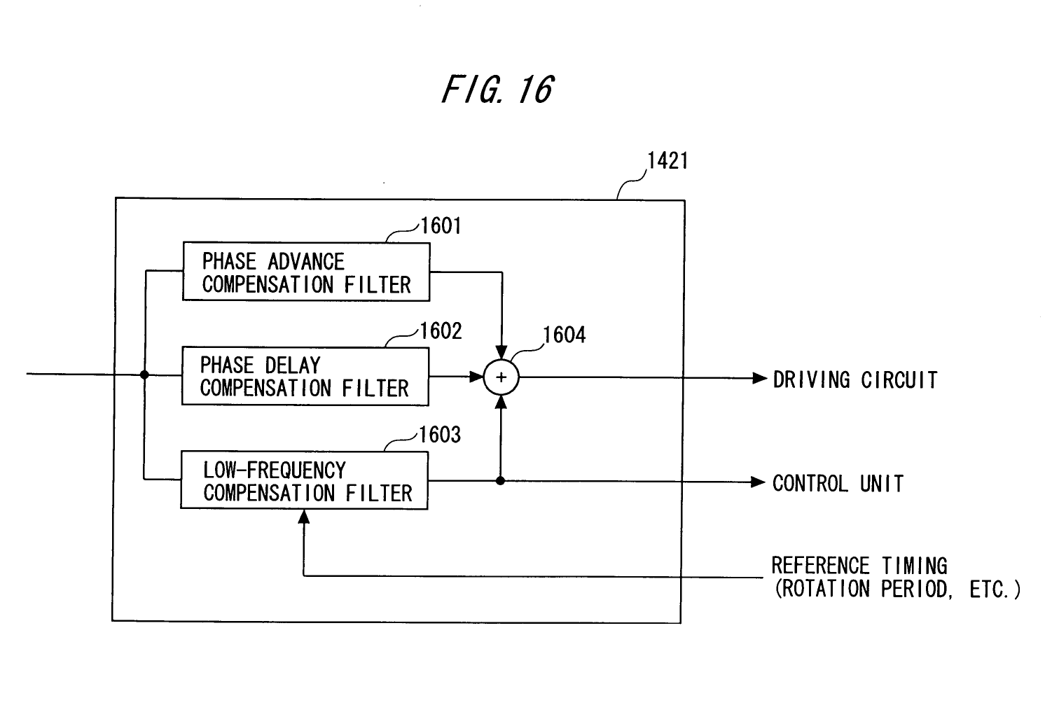

An internal constitution of the track control unit shown in FIGS. 14 and 15 will be explained with reference to FIG. 16. FIG. 16 is an internal block of the track control unit shown in FIGS. 14 and 15.

An output of the AMP 1420 for track error signal sensitivity correction is inputted to the track control unit 1421.

The track control unit 1421 applies arithmetic operations by a phase advance compensation filter 1601, a phase delay compensation filter 1602, and a low-frequency compensation filter 1603 to an inputted track error signal and adds a total outputs of the arithmetic operations in an adding circuit 1604.

On the other hand, rotation synchronizing signal timing is inputted to the track control unit 1421 as reference timing.

The track control unit 1421 outputs an output of the low-frequency compensation filter 1603 measured at the reference timing to the control unit 1403.

When carriage driving by step motor driving is performed according to an output of the relative position detection circuit 1431 and the carriage is driven, the control unit 1403 rewrites a track driving indication value stored in the memory 1406.

This is because it is necessary to normalize a relative position displacement amount of the track actuator and the carriage with respect to the track driving indication value.

When there is an error among apparatuses in the output of the relative position detection circuit 1431, timing for driving the carriage by driving of the step motor is different among the apparatuses.

Therefore, when displacement larger than an actual displacement amount is detected, it is difficult to reach a track between phases that hold step motor rotation. When displacement smaller than an actual displacement amount is detected, an actual relative positional displacement amount of the track actuator and the carriage increases.

As a result, it is likely that the track servo becomes unstable, reliability of recording and reproduction is deteriorated because tracking is performed in a position where a track error signal is shifted, or adjacent track data is deteriorated in the worst case.

At the time of carriage driving by step motor driving, the control unit 1403 performs processing for rewriting a track driving indication value stored in the memory 1406. However, whereas the carriage moves 50 μm, the track actuator is corrected excessively or a correction amount is insufficient. Consequently, track servo stability is spoiled.

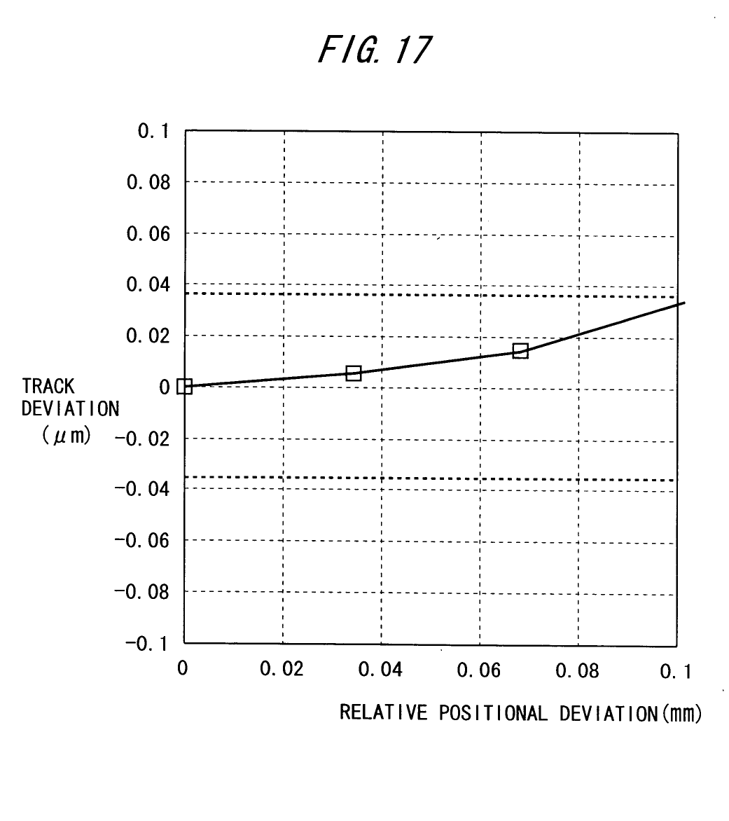

Deviation from a track center at the time when relative displacement of the track actuator and the carriage occurs in the third embodiment of the tracking device according to the present invention will be explained. FIG. 17 is a graph showing deviation from the track center at the time when relative displacement of the track actuator and the carriage occurs in the third embodiment of the tracking device according to the present invention.

When relative displacement is 0, a beam follows a track center. However, relative positional deviation occurs because of medium eccentricity and a carriage stop position.

For example, assuming that a recording and reproduction characteristic is affected when ±0.036 μm or more deviation from the track center occurs, maximum relative positional deviation of about 100 μm is allowed.

In the system in this embodiment, since displacement is detected from a low-frequency component of a track driving indication value to drive the carriage, assuming that ±30 μm relative positional deviation due to eccentricity of a medium or the like occurs, the carriage has to be driven at a point when maximum DC displacement of 100−30=±70 μm is detected.

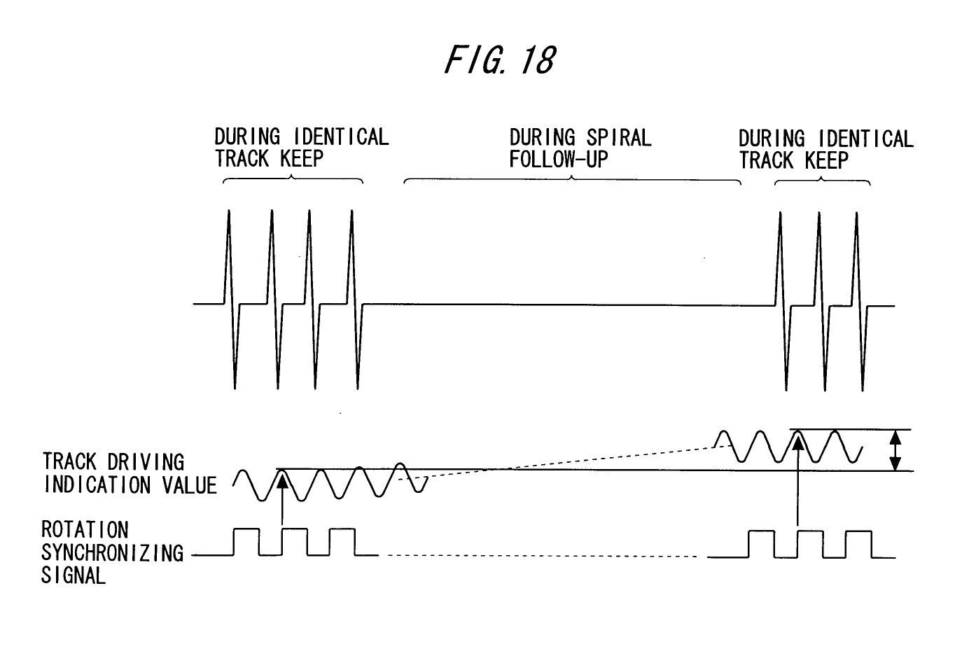

Thus, normalization of a relative positional displacement amount of the track actuator and the carriage with respect to a low-frequency component of a track driving indication value will be explained with reference to FIG. 18.

FIG. 18 is a conceptual diagram showing behaviors of a low-frequency component of a track driving indication value at the time when jump of one track is performed for one rotation of a medium and, from an identical track keep state, track jump is stopped for a period corresponding to a specified number of tracks, only the track actuator is caused to spirally follow the track with the carriage fixed, and the tracking device is brought into the identical track keep state again.

Since only the track actuator is caused to spirally follow the track with the carriage fixed, relative displacement of the track actuator and the carriage occurs.

Then, since the track actuator supported by the spring is driven, a low-frequency component of a track driving indication value proportional to a displacement amount occurs.

The track driving indication value is w-sampled at, for example, rising edge timing of a rotation synchronizing signal.

In this embodiment, the number of tracks is derived from a difference between an original track number and a track number after displacement and a displacement amount is derived by multiplying the number of tracks by a track pitch. A driving sensitivity coefficient of the low-frequency component of the track driving indication value with respect to reference displacement is derived by calculating a difference between a low-frequency component of a track driving indication value of an original track sampled and a low-frequency component of a track driving indication value after displacement and by dividing a result of the calculation by the displacement amount.

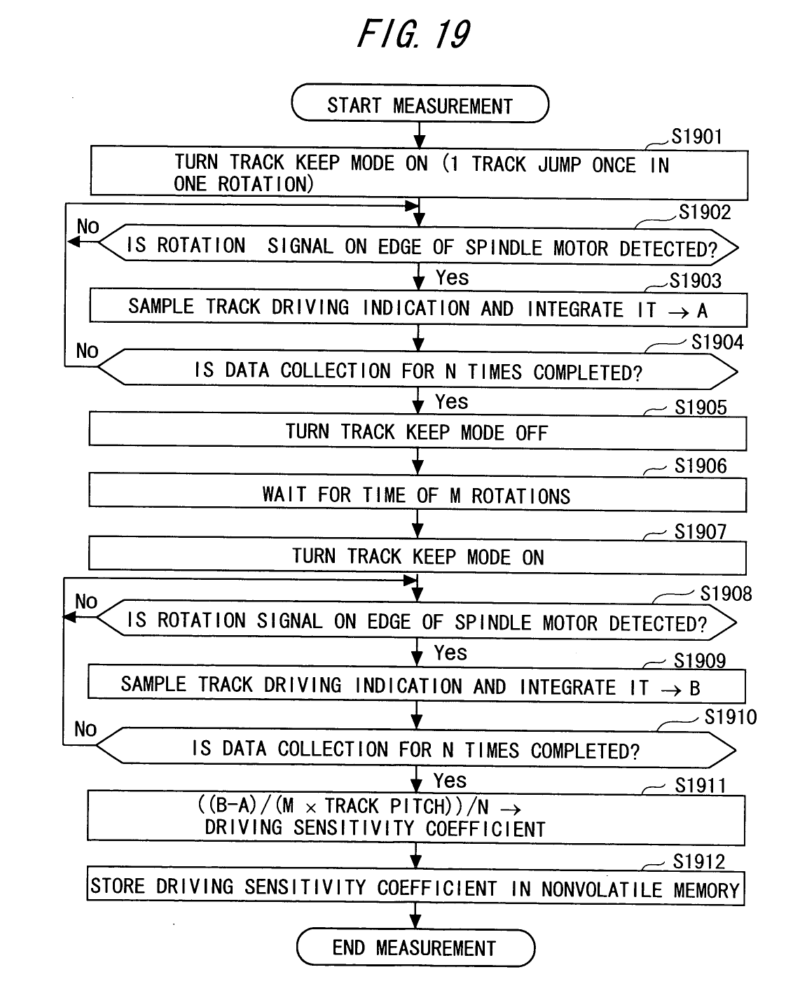

Operations in the third embodiment of the tracking device according to the present invention will be explained with reference to FIG. 19. FIG. 19 is a flowchart of the operations in the third embodiment of the tracking device according to the present invention.

In this embodiment, when measurement processing is executed, the MPU sets the tracking device in a track keep mode for continuing to track an identical track (S1901).

In actual control, track jump is performed once in one rotation.

The control unit detects an edge of a rotation signal of the spindle motor (S1902).

The control unit samples a low-frequency component of a track driving indication value at predetermined timing synchronizing with the rotation signal of the spindle motor and integrates sampled values to A (S1903 and S1904). In this embodiment, data acquisition for n times is performed. The integration processing for plural times has an object of removing noise.

The MPU turns off the track keep mode and waits for the time of specified rotations m (S1905 and S1906). According to the waiting, the track actuator follows a track formed in a spiral shape on a disk to cause relative positional displacement of the carriage and the track actuator.

The MPU sets the tracking device in the track keep mode again (S1907).

The control unit detects an edge of a rotation signal of the spindle motor again (S1908).

The control unit samples a low-frequency component of a track driving indication value at predetermined timing synchronizing with the rotation signal of the spindle motor and integrates sampled values to B (S1909 and S1910). Note that, in this embodiment, data acquisition for n times is performed.

The predetermined timing synchronizing with the rotation signal of the spindle motor in S1909 is the same as the predetermined timing synchronizing with the rotation signal of the spindle motor in S1903. Consequently, the control unit samples a low-frequency component of a track driving indication value at an identical rotation angle during disk rotation.

The control unit calculates ((B−A)/(m×track pitch))/n to obtain a driving sensitivity coefficient (S1911).

The MPU stores the driving sensitivity coefficient received from the control unit 3 in a nonvolatile memory 51 (S1912).

Processing for calculating a low-frequency component of a track driving indication value from an edge of a rotation signal of the spindle motor is performed by the control unit in the DSP.

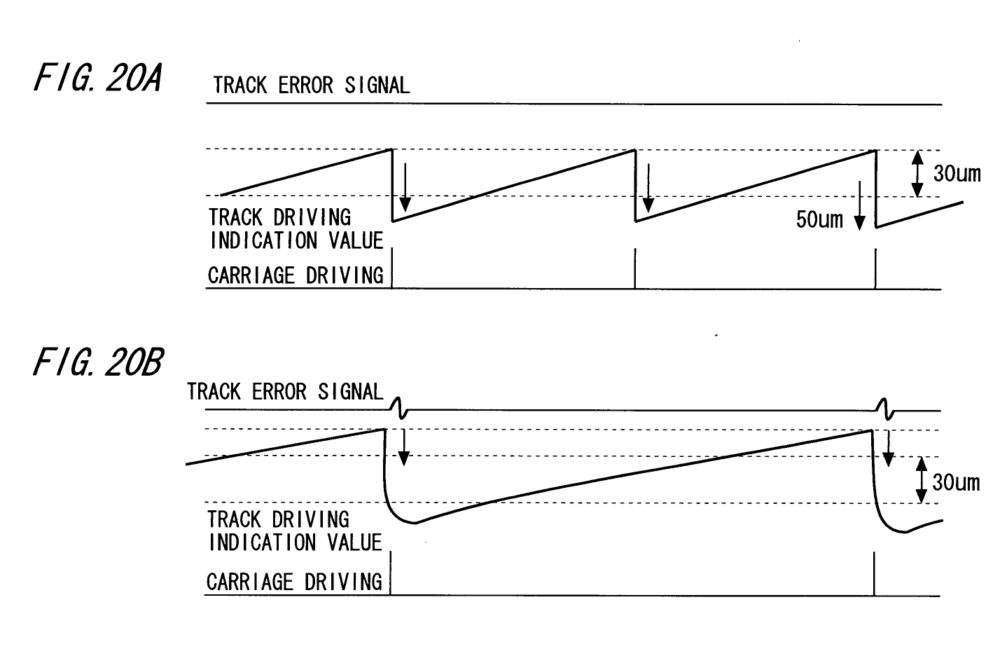

A result of application of the third embodiment of the tracking device according to the present invention will be explained with reference to FIGS. 20A and 20B. FIGS. 20A and 20B is a conceptual diagram showing a track error signal, a track driving indication value, and a driving state of the carriage in the case in which the track actuator is caused to spirally follow a track in the third embodiment of the tracking device according to the present invention.

FIG. 20A is a result of applying this embodiment and FIG. 20B is a conventional example.

As shown in FIG. 20A, in this embodiment, relative displacement of 30 μm is detected from a low-frequency component of a track driving indication value, the carriage is driven, and the track driving indication value is changed by −50 μm.

As the result of application of this embodiment, a behavior at that point does not occur in the track error signal. The track error signal is stable.

On the other hand, a behavior in the case in which a driving sensitivity coefficient of a low-frequency component of a track driving indication value with respect to reference displacement is not normalized and includes an error is shown in FIG. 20B.

FIG. 20B shows a case in which a driving sensitivity coefficient of a low-frequency component of a track driving indication value with respect to reference displacement is smaller than actual displacement.

FIG. 20B, it is detected that relative displacement is equal to or larger than a specified value when the relative displacement exceeds specified 30 μn and it is intended to change the track driving indication value by −50 μm according to rewriting of the low-frequency component of the track driving indication value at the time when the carriage is driven. However, the relative displacement is smaller than actual displacement.

As a result, in FIG. 20B, a behavior at that time appears in a track error signal and spoils track servo stability.

Note that detection of a low-frequency component of a track driving indication value may be measured in a state in which spindle motor rotation is stopped. In this case, it is unnecessary to take into account a rotation angle.

In this way, in the third embodiment of the tracking device according to the present invention, it is possible to accurately calculate a driving sensitivity coefficient of the track actuator per a unit distance.

(Fourth Embodiment of the Tracking Device)

A fourth embodiment of the tracking device according to the present invention will be explained. The fourth embodiment of the tracking device according to the present invention is an embodiment in which movement of the track actuator by spiral follow-up to a track with the carriage fixed performed in the third embodiment of the tracking device according to the present invention is replaced with track jump of the track actuator with the carriage fixed.

In other words, a constitution and the other operations of the fourth embodiment of the tracking device according to the present invention are the same as those in the third embodiment of the tracking device according to the present invention. Thus, explanations of the constitution and the other operations of the fourth embodiment are omitted.

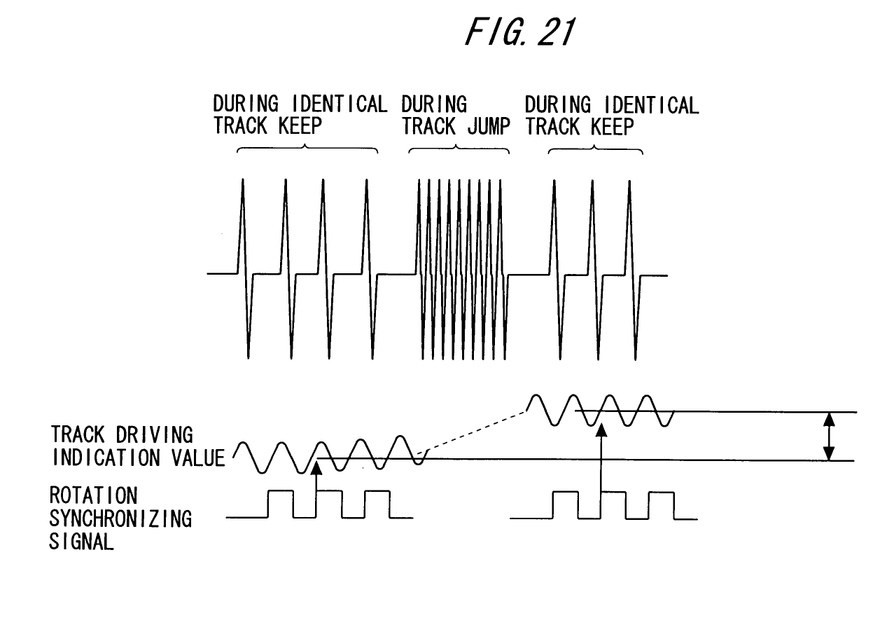

FIG. 21 is a conceptual diagram showing behaviors of a low-frequency component of a track driving indication value at the time when, from an identical track keep state realized by performing jump of one track for one rotation of an information recording medium, the track keep state is released during a period corresponding to a specified number of tracks, only the track actuator is caused to perform track jump with a carriage fixed, and the tracking device is brought into the identical track keep state again in the fourth embodiment of the tracking device according to the present invention.

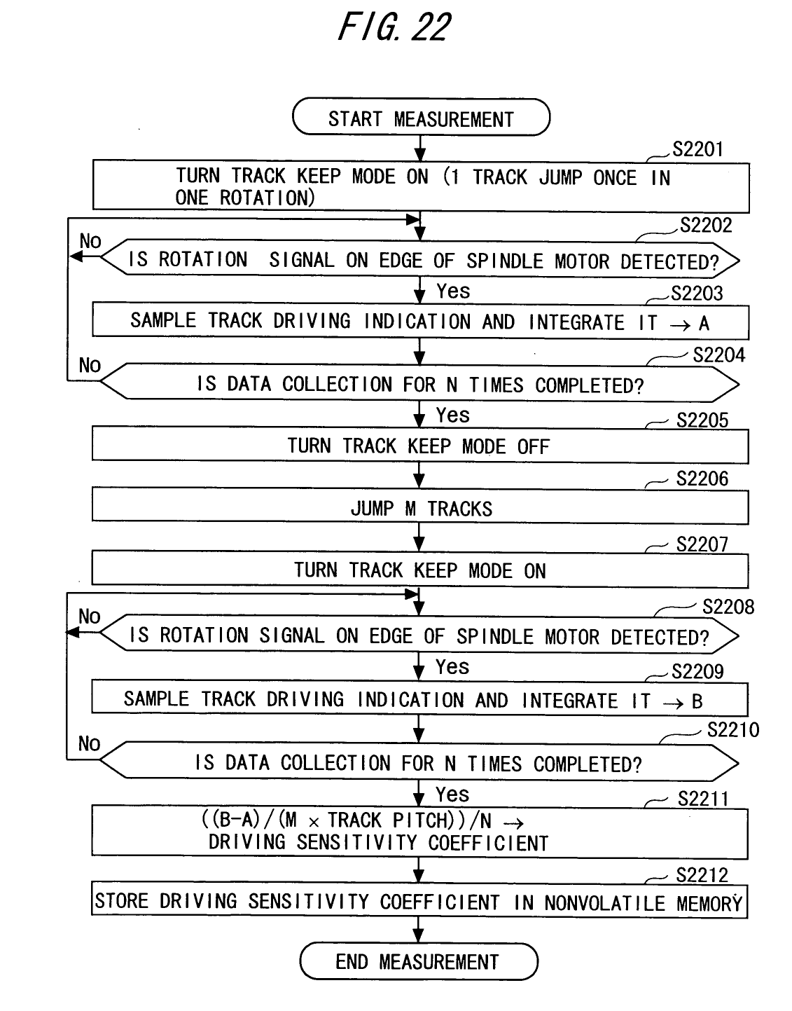

FIG. 22 shows a flowchart of operations in the fourth embodiment of the tracking device according to the present invention.

In the flowchart shown in FIG. 22, the waiting operation for the time of m rotations in S1906 shown in FIG. 19 is replaced with an m track jump operation. The other operations are the same as those in the third embodiment.

In this embodiment, when measurement processing is executed, the MPU sets the tracking device in a track keep mode for continuing to track an identical track (S2201).

In actual control, track jump is performed once in one rotation.

The control unit detects an edge of a rotation signal of the spindle motor (S2202).

The control unit samples a low-frequency component of a track driving indication value and integrates the sampled values to A (S2203 and S2204).

In this embodiment, data acquisition for n times is performed. The integration processing for plural times has an object of removing noise.

The MPU turns off the track keep mode and causes the track actuator to perform track jump for time of specified rotations m (S2205 and S2206).

According to the track jump, the track actuator performs jump a track formed in a spiral shape on a disk to cause relative positional displacement of the carriage and the track actuator.

The MPU sets the tracking device in the track keep mode again (S2207).

The control unit detects an edge of a rotation signal of the spindle motor again (S2208).

The control unit samples a low-frequency component of a track driving indication value and integrates the sampled values to B (S2209 and S2210). Note that, in this embodiment, data acquisition for n times is performed.

The predetermined timing synchronizing with the rotation signal of the spindle motor in S2209 is the same as the predetermined timing synchronizing with the rotation signal of the spindle motor in S2203. Consequently, the control unit samples a low-frequency component of a track driving indication value at an identical rotation angle during disk rotation.

The control unit calculates ((B−A)/(m×track pitch))/n to obtain a driving sensitivity coefficient (S2211).

The MPU stores the driving sensitivity coefficient received from the control unit in a nonvolatile memory (S2212).

Processing for calculating a low-frequency component of a track driving indication value from an edge of a rotation signal of the spindle motor is performed by the control unit in the DSP.

As described above, in the fourth embodiment of the tracking device according to the present invention, as in the third embodiment of the tracking device according to the present invention, it is possible to accurately calculate a driving sensitivity coefficient of the track actuator.

(Fifth Embodiment of the Tracking Device)

A fifth embodiment of the tracking device according to the present invention will be explained. The tracking device in this embodiment performs track jump from a state in which rotation of a disk serving as an information recording medium is stopped and a track servo loop is closed.

In other words, a constitution and the other operations in the fifth embodiment of the tracking device according to the present invention are the same as those in the third embodiment of the tracking device according to the present invention.

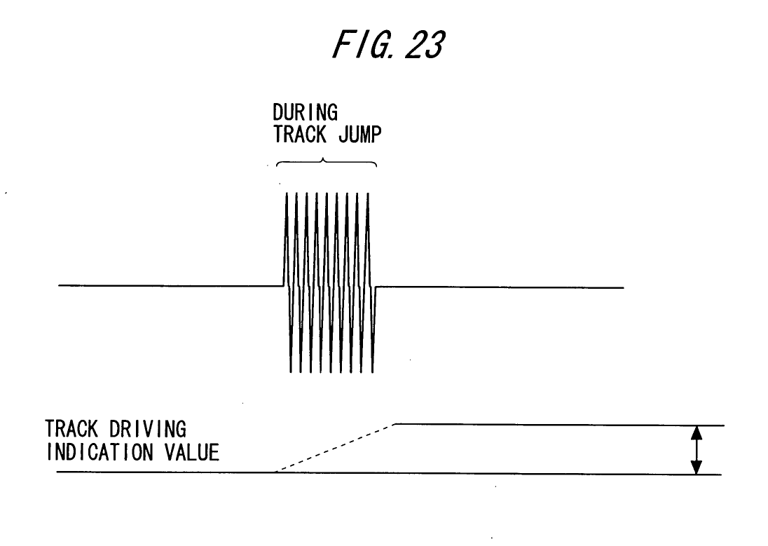

FIG. 23 is a conceptual diagram showing a change in track drive indication before and after track jump when rotation of a disk serving as an information recording medium is stopped and, from a state in which a track servo loop is closed, the track jump is performed in the fifth embodiment of the tracking device according to the present invention.

Since the track jump is performed, displacement occurs in relative positions of the track actuator and the carriage and a track driving indication value proportional to a displacement amount occurs.

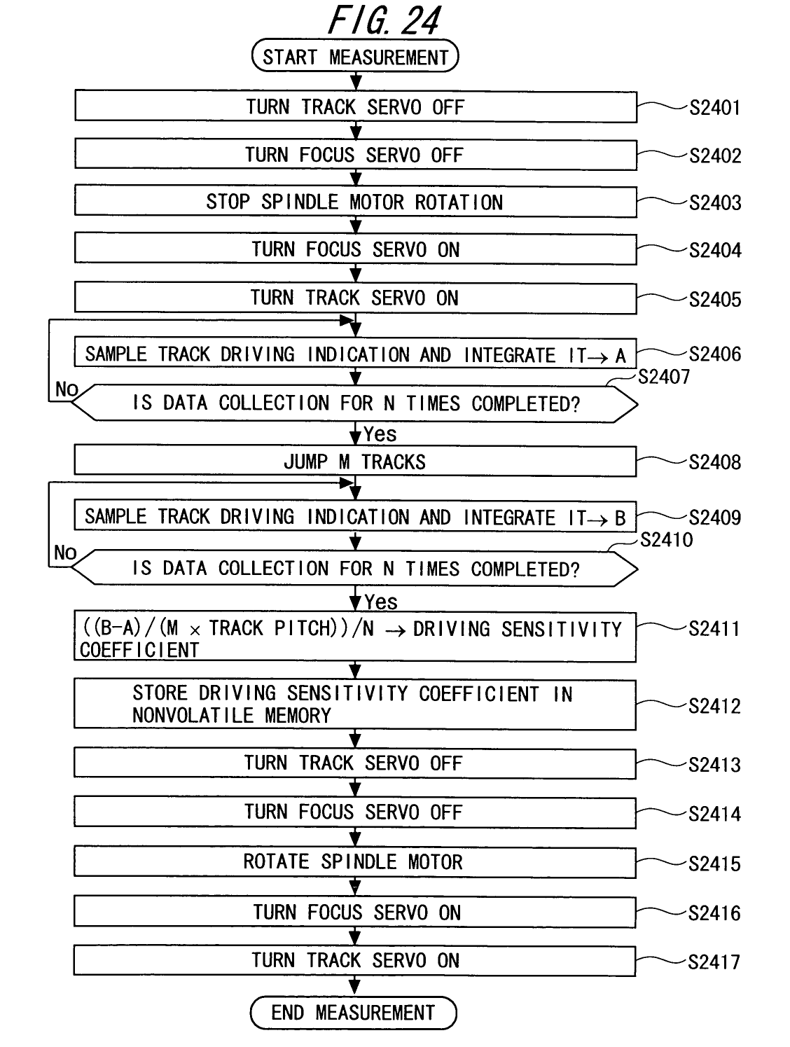

Operations in the fifth embodiment of the tracking device according to the present invention will be explained with reference to FIG. 24. FIG. 24 is a flowchart of an operation in the fifth embodiment of the tracking device according to the present invention.

In this embodiment, when measurement processing is executed, the MPU turns off a track servo and a focus servo once and stops spindle motor rotation (S2401, S2402, and S2403).

The MPU turns on the focus servo and the track servo again (2404 and 2405).

The control unit samples track driving indication values and integrates the track driving indication values sampled into A (S2406 and S2407). In this embodiment, data acquisition for n times is performed. The integration processing for plural times has an object of removal of noise.

The MPU causes the track actuator to jump m tracks (S2408) to cause relative positional displacement of the track actuator and the carriage.

Again, the control unit samples track driving indication values and integrates the track driving indication values sampled into B (S2409 and S2410). In this embodiment, data acquisition for n times is performed.

The control unit calculates ((B−A)/(m×track pitch))/n to obtain a driving sensitivity coefficient (S2411).

The control unit instructs the MPU to store the driving sensitivity coefficient in the nonvolatile memory 51. The MPU stores the driving sensitivity coefficient received from the control unit in the nonvolatile memory 51 (S2412).

Thereafter, the MPU turns of the track servo (S2413), turns off the focus servo (S2414), rotates the spindle motor (S2415), turns on the focus servo (S2416), and turns on the track servo (S2417).

The control unit 3 in the DSP 2 performs the processing for calculating a track driving indication value.

In this embodiment, the relative displacement detection circuit divides the measured track driving indication value by the driving sensitivity coefficient to detect a relative positional deviation amount between the track actuator and the carriage and, when the relative positional deviation amount detected reaches a predetermined value, instructs the track actuator to drive the carriage.

In this way, in the fifth embodiment of the tracking device according to the present invention, as in the third embodiment of the tracking device according to the present invention, it is possible to accurately calculate a driving sensitivity coefficient of the track actuator.

(Sixth Embodiment of the Tracking Device)

A sixth embodiment of the tracking device according to the present invention will be explained with reference to the drawings.

The tracking device in this embodiment drives to rotate a step motor by one step during identical track keep.

In other words, a constitution and the other operations in the sixth embodiment of the tracking device according to the invention are the same as the constitution and the other operations in the third embodiment of the tracking device according to the present invention.

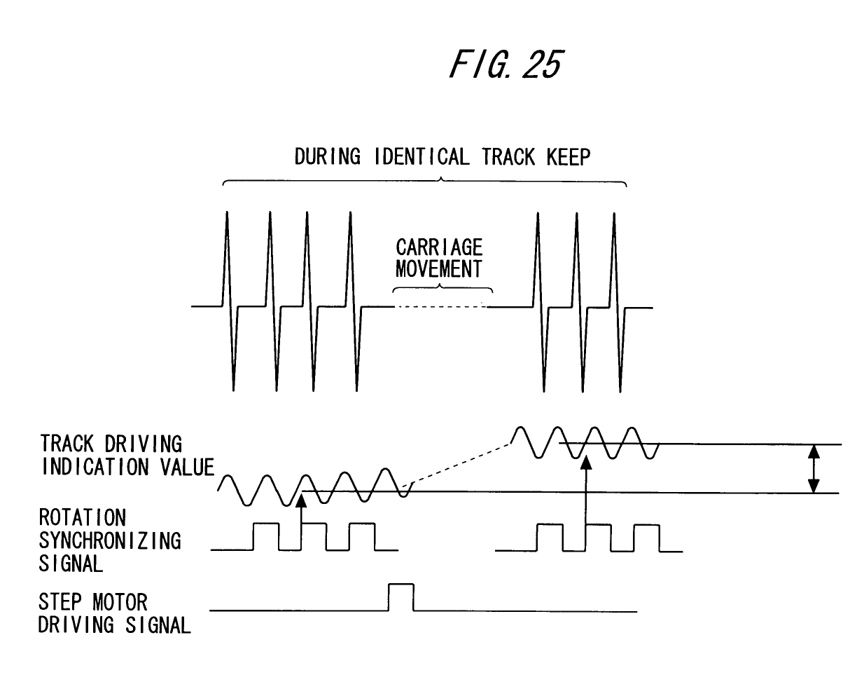

FIG. 25 is a conceptual diagram showing a change in a low-frequency component of a track driving indication value before and after driving when a step motor is driven to rotate by one step during identical track keep and a carriage is driven (50 [μm]) in a sixth embodiment of the tracking device according to the present invention.

By driving the carriage while keeping the track actuator at the same track, displacement occurs in relative positions between the track actuator and the carriage, and a low-frequency component of a track driving indication value proportional to a displacement amount is generated.

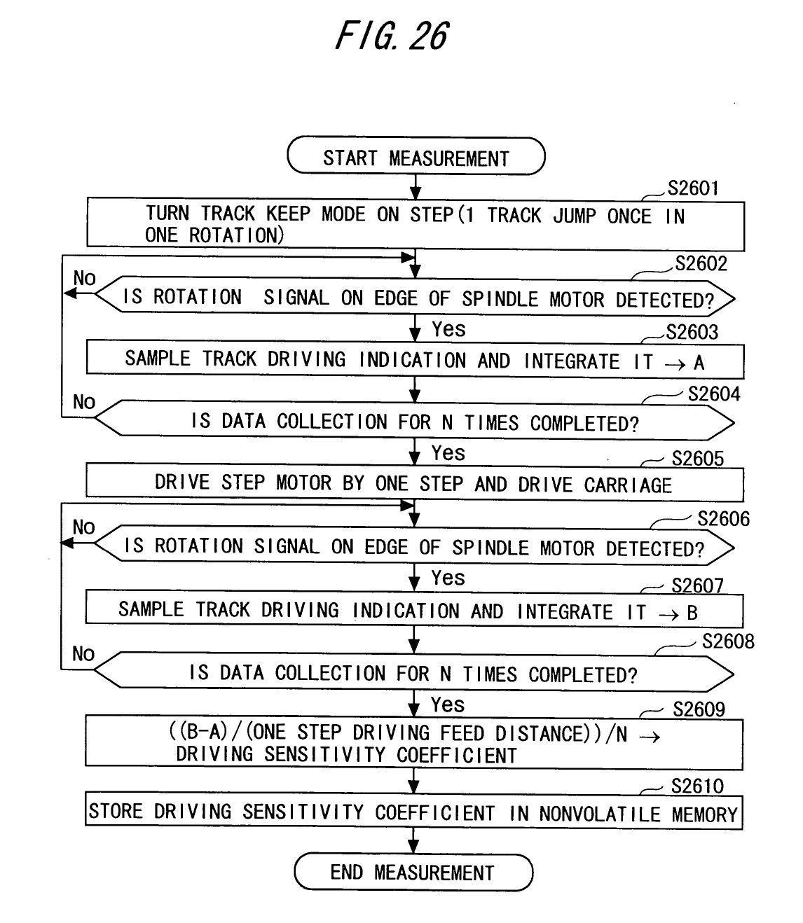

Operations in the sixth embodiment of the tracking device according to the present invention will be explained with reference to FIG. 26. FIG. 26 is a flowchart of the operations in the sixth embodiment of the track actuator according to the present invention.

In this embodiment, when measurement processing is executed, the MPU sets the track actuator in a track keep mode for continuing to track an identical track (S2601).

In actual control, track jump is performed once in one rotation.

The control unit detects an edge of a rotation signal of the spindle motor (S2602).

The control unit samples a low-frequency component of a track driving indication value at predetermined timing synchronizing with the rotation signal of the spindle motor and integrates sampled values into A (S2603 and S2604). In this embodiment, data acquisition for n times is performed.

The integration processing for plural times has an object of removing noise.

The MPU drives to rotate the step motor by one step to move the carriage (S2605). Since a track of the track actuator maintains a keep state, relative positional displacement occurs between the carriage and the track actuator because of the movement of the carriage.

The control unit detects an edge of a rotation signal of the spindle motor again (S2606).

The control unit samples a low-frequency component of a track driving indication value at predetermined timing synchronizing with the rotation signal of the spindle motor and integrates sampled values into B (S2607). Note that, in this embodiment, data acquisition for n times is performed.

The predetermined timing synchronizing with the rotation signal of the spindle motor in S2607 is the same as the predetermined timing synchronizing with the rotation signal of the spindle motor in S2603. Consequently, the control unit samples a low-frequency component of a track driving indication value at an identical rotation angle during disk rotation.

The control unit calculates ((B−A)/(one step driving feed distance of carriage))/n to obtain a driving sensitivity coefficient (S2609).

The control unit instructs the MPU to store the driving sensitivity coefficient in the nonvolatile memory 51. The MPU stores the driving sensitivity coefficient received from the control unit in the nonvolatile memory 51 (S2610).

Processing for calculating a low-frequency component of a track driving indication value from an edge of a rotation signal of the spindle motor is performed by the control unit 3 in the DSP 2.

As described above, in the sixth embodiment of the tracking device according to the present invention, as in the third embodiment of the tracking device according to the present invention, it is possible to accurately calculate a driving sensitivity coefficient of the track actuator.

(Seventh Embodiment of the Tracking Device)

A seventh embodiment of the tracking device according to the present invention will be explained with reference to the drawings.

This embodiment is an embodiment for stopping disk rotation and driving to rotate a step motor by one step from a state in which a track servo loop is closed.

In other words, a constitution and the other operations in the seventh embodiment of the tracking device according to the present invention are the same as the constitution and the other operations in the third embodiment of the tracking device according to the present invention.

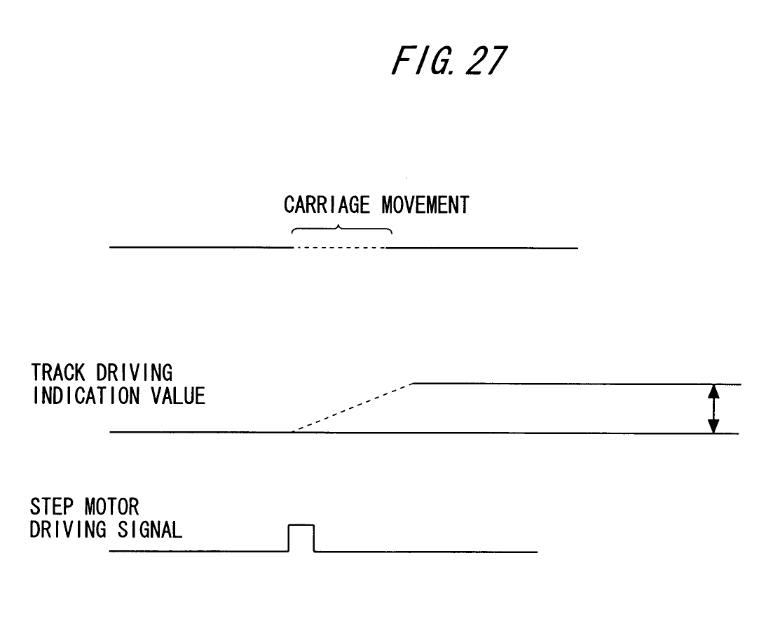

FIG. 27 is a conceptual diagram showing a change in a track driving indication value before and after driving when disk rotation is stopped and, from a state in which a track servo loop is closed, the step motor is driven to rotate one step and the carriage is driven (50 [μm]).

By driving the carriage, displacement occurs in relative positions of the track actuator and the carriage and a track driving indication value proportional to a displacement amount is generated.

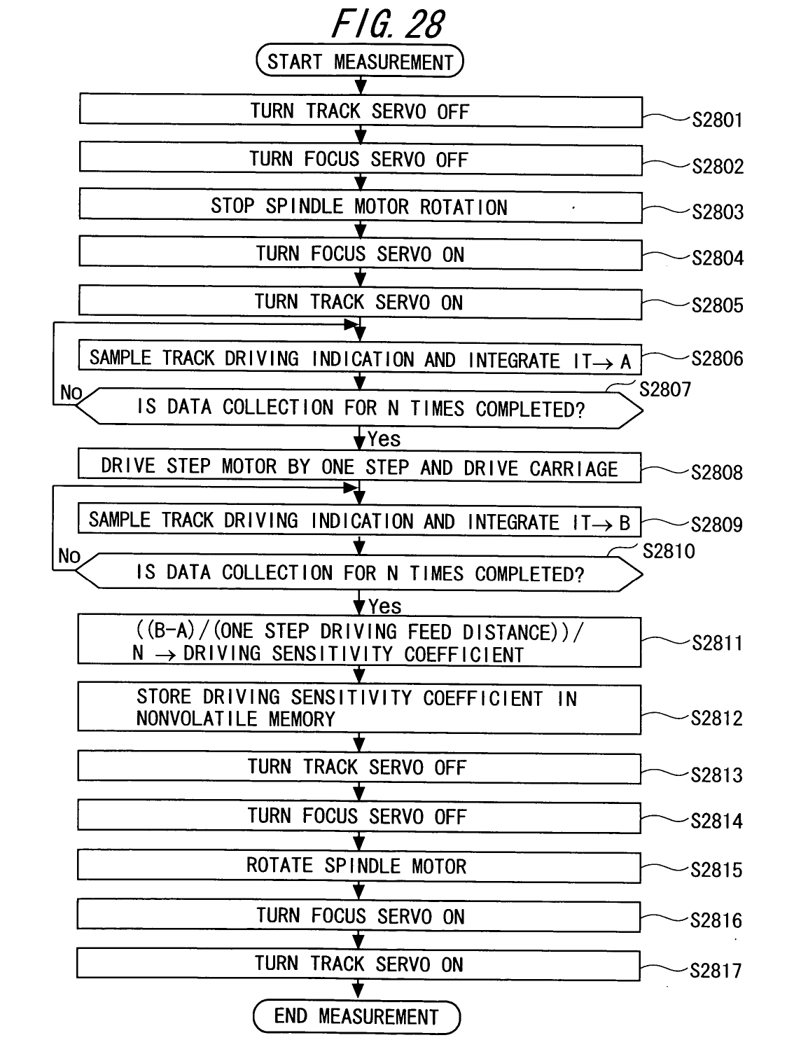

Operations in this embodiment of the tracking device according to the present invention will be explained with reference to FIG. 28. FIG. 28 is a flowchart of an operation in the seventh embodiment of the tracking device according to the present invention.

In this embodiment, when measurement processing is executed, the MPU turns off a track servo and a focus servo once and stops spindle motor rotation (S2801, S2802, and S2803).

The MPU turns on the focus servo and the track servo again (2804 and 2805).

The control unit samples track driving indication values and integrates the track driving indication values sampled into A (S2806 and S2807). In this embodiment, data acquisition for n times is performed. The integration processing for plural times has an object of removal of noise.

The MPU drives to rotate the step motor by one step to drive the carriage (S2808).

Since the track actuator maintains a keep state of a track, relative positional displacement of the carriage and the track actuator occurs.

Again, the control unit samples track driving indication values and integrates the track driving indication values sampled into B (S2809 and S2810). In this embodiment, data acquisition for n times is performed.

The control unit calculates ((B−A)/(one step driving feed distance of carriage))/n to obtain a driving sensitivity coefficient (S2811).

The control unit instructs the MPU to store the driving sensitivity coefficient in the nonvolatile memory 51. The MPU stores the driving sensitivity coefficient received from the control unit in the nonvolatile memory 51 (S2812).

Thereafter, the MPU turns of the track servo (S2813), turns off the focus servo (S2814), rotates the spindle motor (S2815), turns on the focus servo (S2816), and turns on the track servo (S2817).

The control unit in the DSP performs the processing for calculating a low-frequency component of a track driving indication value.

In this way, in the seventh embodiment of the tracking device according to the present invention, as in the third embodiment of the tracking device according to the present invention, it is possible to accurately calculate a driving sensitivity coefficient of the track actuator.

Note that, in the embodiments described above, the optical disk apparatus using an MO medium is explained as an example of the information recording medium. Besides, the present invention may be directly applied to appropriate optical disk apparatuses using a DVD, a phase change medium, and the like.

The present invention is not limited by the numerical values in the embodiments.

Moreover, the present invention includes all modifications in a range in which the objects and the advantages of the present invention are not spoiled.

### INDUSTRIAL APPLICABILITY

As described above, the tracking device according to the present invention is suitable for optical disk apparatuses using information recording media such as an MO medium and a DVD medium.

What is claimed is:

1. A tracking device comprising:
an oscillating unit oscillating a track actuator in a state in which a focus servo loop is closed;
a number-of-track-traverses calculating unit calculating a number of track traverses of the track actuator traversing tracks of an information recording medium from a track error signal obtained by the oscillation; and
an acceleration performance calculating unit calculating an acceleration performance constant of the track actuator from a value based on a ratio of the number of track traverses calculated and a reference number of track traverses.

2. A tracking device according to claim 1, wherein the value based on a ratio of the number of track traverses calculated and a reference number of track traverses is a ratio of a distance obtained by multiplying the calculated number of track traverses by a pitch of the tracks and a value corresponding to a distance obtained by multiplying the reference number of track traverses by the pitch of the tracks.

3. A tracking device according to claim 1,
wherein the calculation of the number of track traverses by the number-of-track-traverses calculating unit is performed in a state in which rotation of the information recording medium is stopped.

4. A tracking device according to claim 1,
wherein the oscillating unit sets an oscillation frequency of the track actuator to a frequency larger than a primary resonance frequency of the track actuator.

5. A tracking device according to claim 1,
wherein the oscillating unit sets, assuming that n is a natural number, an oscillation period of the track actuator to a period 1/n times as large as a rotation period of the information recording medium,
the number-of-track-traverses calculating unit calculates, assuming that k is ½ or a natural number, a first number of track traverses while the track actuator is oscillated by the oscillating unit and the information recording medium rotates k times, calculates a second number of track traverses due to eccentricity of the information recording medium while the information recording medium rotates k times in a state in which the track actuator is not oscillated by the oscillating unit, and calculates a third number of track traverses by subtracting the second number of track traverses from the first number of track traverses, and
the acceleration performance calculating unit calculates an acceleration performance constant of the track actuator from a ratio of the third number of track traverses and the reference number of track traverses.

6. A tracking device comprising:
a track actuator supported by a carriage;
a first measuring unit measuring first value of a track driving indication value at a specific rotation angle during rotation of an information recording medium in a state in which the track actuator is located in a first position on the carriage and a track servo loop is closed and measures a second value of the track driving indication value at a rotation angle identical with the specific rotation angle in a state in which the carriage is not driven, the track actuator is located in a second position on the carriage shifted by a predetermined number of tracks from the first position, and the track servo loop is closed; and
a control unit calculating driving sensitivity coefficient of a track driving indication value by dividing a difference between the first value and the second value measured by a distance between the first position and the second position on the carriage obtained from the predetermined number of tracks.

7. A tracking device according to claim 6, further comprising moving unit causing the track actuator to spirally follow tracks of the information recording medium and moves the track actuator by the predetermined number of tracks.

8. A tracking device according to claim 6, further comprising moving unit causing the track actuator to perform track jump and moves the track actuator by the predetermined number of tracks.

9. A tracking device according to claim 6, wherein the specific rotation angle is an angle at predetermined timing synchronizing with a rotation signal of a spindle motor.

10. A tracking device according to claim 6, further comprising output unit detecting a relative positional deviation amount between the track actuator and the carriage by dividing a low-frequency component of the track driving indication value measured at predetermined timing by the driving sensitivity coefficient or detects a relative positional deviation amount between the track actuator and the carriage by dividing a low-frequency component of the track driving indication value by the driving sensitivity coefficient and, then, measuring the low-frequency component of the track driving indication value at predetermined timing and outputs, when the relative positional deviation amount between the track actuator and the carriage detected reaches a predetermined value, a signal for driving the carriage.

11. A tracking device according to claim 6, further comprising:
a second measuring unit measuring, when the carriage is driven, a low-frequency component of the track driving indication value at predetermined timing; and
a storing unit storing the track driving indication value measured by the second measuring unit,
wherein the control unit updates the low-frequency component of the track driving indication value stored in the storing unit with a value measured by the second measuring unit.

12. A tracking device comprising:
a track actuator supported by a carriage;
a first measuring unit measuring a first value of a track driving indication value in a state in which rotation of an information recording medium is stopped, the track actuator is located in a first position on the carriage and a track servo loop is closed and measures a second value of the track driving indication value in a state in which rotation of an information recording medium is stopped, the carriage is not driven, the track actuator is located in a second position on the carriage shifted by a predetermined number of tracks from the first position, and the track servo loop is closed; and
a control unit calculating a driving sensitivity coefficient of a track driving indication value by dividing a difference between the first track driving indication value and the second track driving indication value by a distance between the first position and the second position on the carriage obtained from the predetermined number of tracks.

13. A tracking device according to claim 12, further comprising moving unit causing the track actuator to perform track jump and moves the track actuator by the predetermined number of tracks.

14. A tracking device according to claim 12, further comprising output unit detecting a relative positional deviation amount between the track actuator and the carriage by dividing the track driving indication value measured by the driving sensitivity coefficient and outputs, when the relative positional deviation amount between the track actuator and the carriage detected reaches a predetermined value, a signal for driving the carriage.

15. A tracking device according to claim 12, further comprising:
a second measuring unit measuring, when the carriage is driven, the track driving indication value; and
a storing unit storing the track driving indication value measured by the second measuring unit,
wherein the control unit updates the track driving indication value stored in the storing unit with a value measured by the second measuring unit.

16. A tracking device comprising:
a track actuator supported by a carriage;
a first measuring unit measuring a first value of a track driving indication value at a specific rotation angle during rotation of an information recording medium in a state in which the track actuator is located in a first position on the carriage and a track servo loop is closed and measures a second value of the track driving indication value at a rotation angle identical with the specific rotation angle in a state in which, while the track actuator continues to be located in a track identical with a track where the track actuator is located in the first position, the carriage is driven, the track actuator is located in a second position on the carriage shifted from the first position, and the track servo loop is closed; and
a control unit calculating a driving sensitivity coefficient of a track driving indication value by dividing a difference between the first value and the second value by a distance between the first position and the second position measured on the carriage obtained from a driving amount of the carriage.

17. A tracking device according to claim 16,
wherein the specific rotation angle is an angle at timing synchronizing with a rotation signal of a spindle motor.

18. A tracking device according to claim 16, further comprising:
a second measuring unit measuring, when the carriage is driven, a low-frequency component of the track driving indication value at predetermined timing; and
a storing unit storing the track driving indication value measured by the second measuring unit,
wherein the control unit updates the low-frequency component of the track driving indication value stored in the storing unit with a value measured by the second measuring unit.

19. A tracking device comprising:
a track actuator supported by a carriage;
a first measuring unit measuring a first track driving indication value in a state in which the track actuator is located in a first position on the carriage, rotation of an information recording unit is stopped, and a track servo loop is closed and measures a second track driving indication value in a state in which, while the track actuator continues to be located in a track identical with a track where the track actuator is located in the first position, the carriage is driven, the track actuator is located in a second position on the carriage shifted from the first position, rotation of the information recording medium is stopped, and the track servo loop is closed; and
a control unit calculating a driving sensitivity coefficient for a track driving indication value by dividing a difference between the first track driving indication value and the second track driving indication value by a distance between the first position and the second position obtained from a driving amount of the carriage.

20. A tracking device according to claim 19, further comprising:
a second measuring unit measuring, when the carriage is driven, the track driving indication value; and
a storing unit storing the track driving indication value measured by the second measuring unit,
wherein the control unit updates the track driving indication value stored in the storing unit with a value measured by the second measuring unit.
